(19) United States
(12) Patent Application Publication
(10) Pub. No.: US 2015/0136758 A1
(43) Pub. Date: May 21, 2015

(54) MICROWAVE HEATING DEVICE

(71) Applicant: Panasonic Intellectual Property Management Co. Ltd., Osaka-shi, Osaka (JP)

(72) Inventors: Koji Yoshino, Shiga (JP); Masafumi Sadahira, Shiga (JP); Daisuke Hosokawa, Shiga (JP); Tomotaka Nobue, Nara (JP); Yoshiharu Omori, Shiga (JP)

(21) Appl. No.: 14/400,493

(22) PCT Filed: Apr. 26, 2013
(86) PCT No.: PCT/JP2013/002864

§ 371 Date: Nov. 11, 2014

(30) Foreign Application Priority Data
May 15, 2012 (JP) 2012-111224

(51) Int. Cl. H05B 6/70; H05B 6/72

(52) U.S. Cl. CPC H05B 6/707; H05B 6/72
USPC 219/690

(57) ABSTRACT

In order to radiate microwaves from a waveguide tube to a whole area from end to end of a radiation area within a heating chamber, and to heat uniformly an object to be heated without using a driving mechanism, a microwave heating device of the present invention includes openings for radiating the microwave from the waveguide tube to the inside of the heating chamber. The heating chamber includes a radiation area which has a length of approximate twice an in-tube wavelength in a propagation direction of the waveguide tube. Also, the openings are arranged to have an interval of approximate the in-tube wavelength in the propagation direction of the waveguide tube, and are symmetrically arranged to a center line which intersects perpendicularly to the propagation direction in the radiation area.

### TECHNICAL FIELD

The present invention relates to microwave heating devices such as microwave ovens which radiate microwaves to objects to be heated so as to perform dielectric heating.

### BACKGROUND ART

A microwave oven, which is a representative microwave heating device, is adapted to supply microwaves radiated from a magnetron, which is a representative microwave generating means, to the inside of a metallic heating chamber through a waveguide tube, thereby causing an object to be heated within the heating chamber to be subjected to dielectric heating through the radiated microwaves. A non-uniform microwave electromagnetic-field distribution within the heating chamber causes that uniform microwave heating for the object to be heated cannot be performed.

Therefore, as means for uniformly heating an object to be heated, there is a mechanism adapted to rotate a table on which an object to be heated is placed so as to rotate the object to be heated, or a mechanism adapted to rotate an antenna which radiates microwaves while fixing the object to be heated. It is a general method for heating uniformly to an object to be heated that the object is heated with changing directions of the microwaves radiated to the object by using any driving mechanism as mentioned above.

On the other hand, in order to constitute simply, a method of carrying out uniform heating without having a driving mechanism is demanded, and a method of using a circular polarization of which a polarization plane of electric field rotates in time is proposed. Since dielectric heating is carried out on the basis of the principle that to-be-heated an object having dielectric loss is heated with the electric field of microwave, it is thought that using the circular polarization of which an electric field rotates has an effect in equalization of heating. As concrete way for generating the circular polarization, for example, as shown in FIG. 12, U.S. Pat. No. 4,301,347 (Patent Literature 1) discloses a structure using a circular-polarization opening 2 of an X-like form which is formed to have an intersected shape on a waveguide tube 1. Also, Japanese Patent No. 3,510,523 (Patent Literature 2) discloses a structure which arranges two openings 3, 4 of rectangular slits to be extended in a direction perpendicular on a waveguide tube, and openings 3, 4 are arranged to have an interval apart from each other, as shown in FIG. 13. Furthermore, Unexamined Japanese Patent Publication No. 2005-235772 (Patent Literature 3) discloses a structure which is configured to generate a circular polarization with cut portions 6 which are formed on a plane of a patch antenna 5 connected to waveguide tube 1, as shown in FIG. 14.

### CITATION LIST

### Patent Literature

PLT 1: U.S. Pat. No. 4,301,347
PLT 2: Japanese Patent No. 3,510,523
PLT 3: Unexamined Japanese Patent Publication No. 2005-235772

### SUMMARY OF THE INVENTION

### Technical Problem

The conventional microwave heating devices disclosed in Patent Literatures 1 to 3 are configured to utilize the above-mentioned circularly-polarized waves. However, the conventional microwave heating devices using the above-mentioned circularly-polarized waves do not have such effect that uniform heating can be performed without the use of such driving mechanism in any case of Patent Literatures 1 to 3. The Patent Literatures 1 to 3 only disclose that equalization can be attained by both effects of the circular polarization and the conventional driving mechanism rather than the only the driving mechanism. Concretely, Patent Literature 1 shown in FIG. 12 discloses a rotating body called a phase shifter 7 which is arranged at an end of the waveguide tube 1. Patent Literature 2 discloses a turntable (not shown) for rotating the object to be heated. Also, Patent Literature 3 discloses a structure which is configured to rotate a patch antenna 5 as a stirrer in addition to a turntable 8. As mentioned above, Patent Literatures 1 to 3 does not disclose such mention that a driving mechanism becomes unnecessary by utilizing the circular polarization. In case that only radiated circularly-polarized waves are used in a microwave heating device, and that any driving mechanism is not provided in the microwave heating device, stirring of microwave is insufficient and uniform heating deteriorates in comparison with a structure having general driving mechanism, for example, a structure for rotating the table on which an object to be heated is placed, and a structure for rotating an antenna.

The present invention is made to overcome the aforementioned problems in the conventional microwave heating device and aims at providing a microwave heating device capable of uniform microwave heating of an object to be heated without using a driving mechanism.

### Solution to Problem

In order to solve the various problems in the conventional microwave heating devices, a microwave heating device according to the present invention comprises

a heating chamber which is adapted to house an object to be heated;

a microwave generating portion which is adapted to generate a microwave;

a waveguide tube which is adapted to propagate the microwave; and

a plurality of microwave radiating portions which are adapted to radiate the microwaves from the waveguide tube to the inside of the heating chamber, wherein

the heating chamber includes a radiation area which is irradiated with the microwaves from the plurality of the microwave radiating portions, and which has a length of approximate twice an in-tube wavelength in a propagation direction of the waveguide tube, and wherein

at least two of the microwave radiating portions are positioned to have an interval of approximate the in-tube wavelength, and are symmetrically arranged to the center line which intersects perpendicularly to the propagation direction in the radiation area.

### Advantageous Effects of Invention

A microwave heating device of the present invention can provide a microwave heating device capable of uniformly heating an object to be heated without using a driving mechanism.

### BRIEF DESCRIPTION OF THE DRAWINGS

FIG. 1 is a perspective view showing an overall configuration of a microwave heating device of a first embodiment according to the present invention.

FIG. 2 is a schematic view showing main components in the microwave heating device of the first embodiment, and includes a sectional plan-view (a) and a sectional front-view (b).

FIG. 3 is a view explaining a positional relationship between an object to be heated and openings in the microwave heating device of the first embodiment.

FIG. 4 is a perspective view explaining a waveguide tube in the microwave heating device of the first embodiment.

FIG. 5 is a view showing simulation results in the microwave heating device of the first embodiment in a condition that an end portion of the waveguide tube as a radiation boundary.

FIG. 6 is a schematic view showing main components in a microwave heating device of a second embodiment, and includes a sectional plan-view (a) and a sectional front-view (b).

FIG. 7 is a schematic view explaining a positional relationship between water loading (in conformity with IEC, five beakers each of which includes 100 m-liter water are placed) and openings in the microwave heating device of the second embodiment.

FIG. 8 is a schematic view explaining a positional relationship between water loading (in conformity with IEC, a container including 1 liter water is placed) and openings in the microwave heating device of the second embodiment.

FIG. 9 is a schematic view showing main components in a microwave heating device of a third embodiment according to the present invention, and includes a sectional plan-view (a) and a sectional front-view (b).

FIG. 10 is a view explaining a condition that a placement plate is not placed in a right position in a microwave heating device of the third embodiment, and includes a sectional plan-view (a) and a sectional front-view (b).

FIG. 11 is a diagram explaining shape examples of openings in a fourth embodiment according to the present invention.

FIG. 12 is the diagram of the configuration of the conventional microwave heating device which generates the circular polarization at the opening having the X-like form.

FIG. 13 is the diagram of the configuration of the conventional microwave heating device which generates the circular polarization by using two rectangular slits at right angles to each other.

FIG. 14 is the diagram of the configuration of the conventional microwave heating device which generates the circular polarization by using the patch antenna.

### DETAILED DESCRIPTION OF THE PREFERRED EMBODIMENTS

A microwave heating device according to a first aspect of the present invention comprises

a heating chamber which is adapted to house an object to be heated;

a microwave generating portion which is adapted to generate a microwave;

a waveguide tube which is adapted to propagate the microwave; and

a plurality of microwave radiating portions which are adapted to radiate the microwaves from the waveguide tube to the inside of the heating chamber, wherein

the heating chamber includes a radiation area which is irradiated with the microwaves from the plurality of the microwave radiating portions, and which has a length of approximate twice an in-tube wavelength in a propagation direction of the waveguide tube, and wherein

at least two of the microwave radiating portions are positioned to have an interval of approximate the in-tube wavelength, and are symmetrically arranged to the center line which intersects perpendicularly to the propagation direction in the radiation area.

In the microwave heating device having the aforementioned structure in the first aspect of the present invention, at least two of the microwave radiating portions, which are positioned to have an interval of approximate the in-tube wavelength, are symmetrically arranged to the center line which intersects perpendicularly to the propagation direction in the radiation area having a length of approximate twice an in-tube wavelength. Therefore, each of the two microwave radiating portions is disposed at just the intermediate position between the center of the radiation area and each end of the radiation area. Also, since the two microwave radiating portions are positioned to have the interval of the in-tube wavelength, the two microwave radiating portions are arranged at the positions having always the positional relationship that the same phase arises, and can always radiate an equivalent quantity of the microwave to the heating chamber from the inside of the waveguide tube.

The microwave heating device having the above-mentioned structure in the first aspect of the present invention is capable of always radiating an equivalent quantity of the microwave from the two microwave radiating portions, which are disposed at just the intermediate positions between the center of the radiation area and each end of the radiation area, respectively. Therefore, the microwave heating device is capable of radiating the microwave to the whole area from end to end of the radiation area, and thereby an object to be heated can be heated uniformly without using a driving mechanism.

The microwave heating device according to a second aspect of the present invention is configured that the radiation area of the above-mentioned first aspect is defined with a placement plate for placing an object to be heated. The microwave heating device having the above-mentioned structure in the second aspect of the present invention is enabled to radiate always an equivalent quantity of the microwave from the two microwave radiating portions, which are disposed at just the intermediate position between the center of the placement plate and each end of the placement plate, respectively. Therefore, the microwave heating device is capable of radiating the microwave to the whole area from end to end of the radiation area, and thereby an object to be heated can be heated uniformly without using a driving mechanism.

The microwave heating device according to a third aspect of the present invention is configured that the radiation area of the above-mentioned first aspect is defined with a space between facing wall surfaces of the heating chamber. The microwave heating device having the above-mentioned structure in the third aspect of the present invention is enabled to radiate always an equivalent quantity of the microwave from the two microwave radiating portions, which are disposed at just the intermediate position between the center of the heating chamber and each end of the heating chamber, respectively. Therefore, the microwave heating device is capable of radiating the microwave to the whole area from end to end of the heating chamber, and thereby an object to be heated can be heated uniformly without using a driving mechanism.

The microwave heating device according to a fourth aspect of the present invention is configured that the radiation area of the above-mentioned first aspect is defined with a bottom space between a position of the microwave radiating portions and a position of a placement plate above the microwave radiating portions. The microwave heating device having the above-mentioned structure in the fourth aspect of the present invention is enabled to radiate always an equivalent quantity of the microwave from the two microwave radiating portions disposed at just the intermediate position between the center of the bottom space and each end of the bottom space, and the bottom space being formed between the microwave radiating portions and the placement plate. Therefore, the microwave heating device is capable of radiating the microwave to the whole area from end to end of the bottom space, and thereby an object to be heated can be heated uniformly without using a driving mechanism.

The microwave heating device according to a fifth aspect of the present invention is configured that at least two of the microwave radiating portions of any one aspect of the above-mentioned first aspect to the fourth aspect are configured to be arranged at positions adjacent to anti-node of a standing wave generated within the waveguide tube. The microwave heating device having the above-mentioned structure in the fifth aspect of the present invention is enabled to radiate many microwaves from the microwave radiating portions which are placed at the position adjacent to the anti-node of the standing wave within the waveguide tube, because the anti-node of the standing wave produces a high electric field. And further, the microwave can be supplied stably from the two microwave radiating portions to the inside of the heating chamber. As a result, the microwave heating device according to the fifth aspect of the present invention can radiate the microwave to the whole area from end to end of the bottom space on-target, and thereby an object to be heated can be heated uniformly without using a driving mechanism.

The microwave heating device according to a sixth aspect of the present invention is configured that at least two of the microwave radiating portions of any one aspect of the above-mentioned first aspect to the fifth aspect are arranged along a propagation direction of the waveguide tube, and at least another microwave radiating portion is formed at a position between the at least two of the microwave radiating portions. For example, in a microwave heating device, in case that a waveguide tube that the in-tube wavelength becomes long is chosen, an interval between the microwave radiating portions becomes a long distance (the radiation area also becoming large). In this case, there is fear that it is hard to heat a middle portion of the radiation area. However, the microwave heating device according to the sixth aspect of the present invention is capable of boosting the heating of the middle portion of the radiation area, and heating the object to be heated uniformly, because other microwave radiating portion(s) is(are) formed between the two of the microwave radiating portions. Furthermore, in general, since it is a very high possibility to place an object to be heated on the center portion of the heating chamber, the microwave heating device according to the sixth aspect of the present invention is configured to have more high heating efficiency by boosting the heating of the middle portion.

The microwave heating device according to a seventh aspect of the present invention is configured that at least two of the microwave radiating portions of any one aspect of the above-mentioned first aspect to the sixth aspect are arranged to be in juxtaposition every two thereof in a width direction of the waveguide tube. The microwave heating device having the above-mentioned structure in the seventh aspect of the present invention has a structure that it is easy to diffuse the microwaves in the width direction of the waveguide tube as well as it is steady to heat uniformly the object to be heated along the propagation direction of the waveguide tube.

The microwave heating device according to an eighth aspect of the present invention is configured that the microwave radiating portions of any one aspect of the above-mentioned first aspect to the seventh aspect have shapes of openings adapted to radiate circular polarizations. The microwave heating device having the above-mentioned structure in the eighth aspect of the present invention can produce the electric field which rotates in all the 360-degree directions peculiar to the circular polarization focusing on the microwave radiating portion. In the microwave heating device according to the eighth aspect of the present invention, the microwave is radiated in the heating chamber so that the microwave is whirl around from the center, and the portion of the circumferential direction in the heating chamber can be heated uniformly. As a result, the microwave heating device according to the eighth aspect of the present invention is capable of radiating the microwaves uniformly to the whole of the heating chamber, and heating the object to be heated uniformly.

The microwave heating device according to a ninth aspect of the present invention is configured that the microwave radiating portion of the above-mentioned eighth aspect is configured with an opening which has an X-like form shaped by two elongated openings intersected with each other. The microwave heating device having the above-mentioned structure in the ninth aspect of the present invention can radiate certainly the circular polarization with a simple structure.

Hereinafter, preferable embodiments of the microwave heating device according to the present invention will be described, with reference to the accompanying drawings. Further, the microwave heating devices according to the following embodiments will be described with respect to microwave ovens, but these microwave ovens are merely illustrative, and the microwave heating device according to the present invention is not limited to such microwave ovens and is intended to include microwave heating devices, such as heating devices, garbage disposers, semiconductor fabrication apparatuses which utilize dielectric heating. Further, the present invention is also intended to cover proper combinations of arbitrary structures which will be described in the following respective embodiments, wherein such combined structures exhibit their respective effects. Further, the present invention is not limited to the concrete structures of the microwave ovens which will be described in the following embodiments and is intended to cover structures based on similar technical concepts.

### First Embodiment

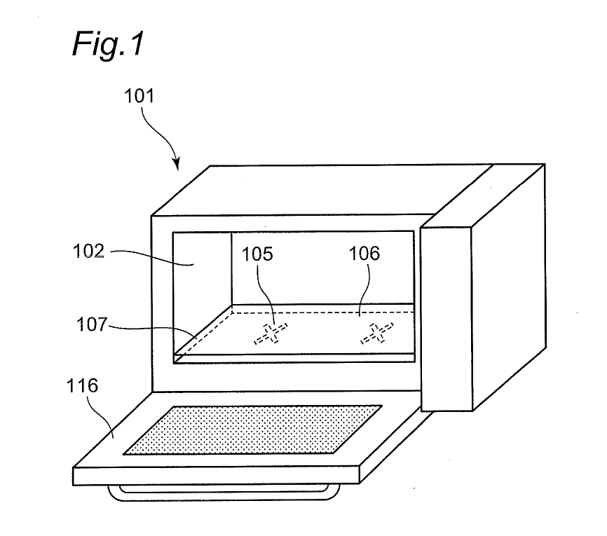

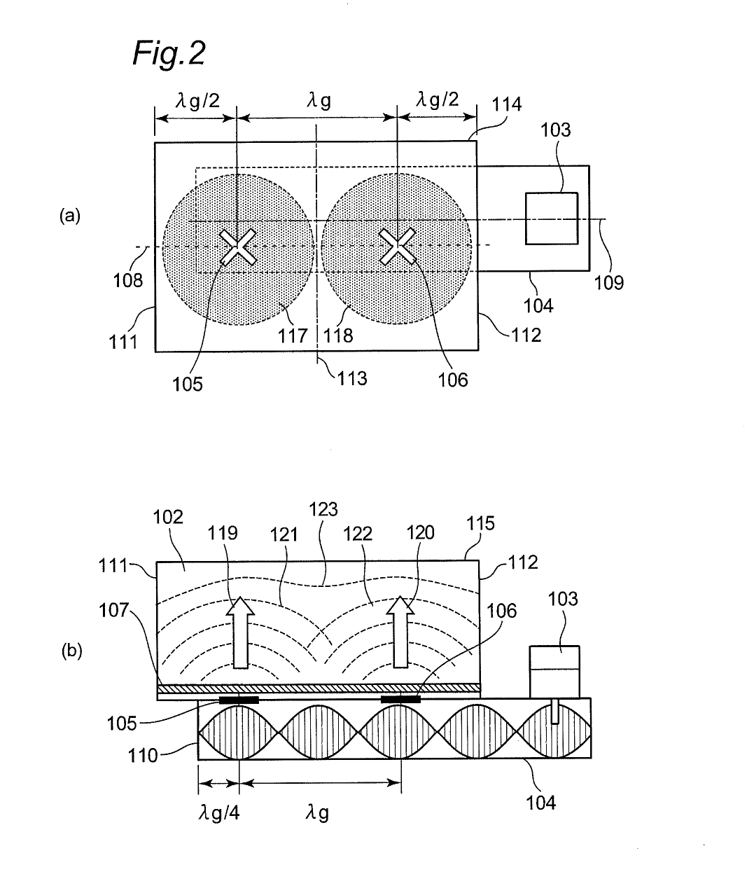

FIGS. 1 and 2 are explanatory diagrams for a microwave heating device according to a first embodiment of the present invention. FIG. 1 is a perspective view showing an overall configuration of the microwave heating device of the first embodiment. FIG. 2 is a schematic view showing main components, such as a microwave generating portion, a waveguide tube and a heating chamber in the microwave heating device of the first embodiment. In FIG. 2, (a) is a sectional view when viewed from above the heating chamber etc., and (b) is a sectional view when viewed from the front side of the heating chamber etc.

A microwave oven 101, which is a representative microwave heating device, includes a heating chamber 102 which is adapted to house food (not illustrated) as a representative object to be heated, a magnetron 103 as a representative microwave generating portion which is adapted to generate a microwave, a waveguide tube 104 which is adapted to propagate the microwave generated in the magnetron 103 to the heating chamber 102, microwave radiating portions 105, 106 which are adapted to radiate the microwaves within the waveguide tube 104 to the inside of the heating chamber 102, and a placement plate 107 on which food is placed. The microwave radiating portions 105, 106 in the first embodiment are structured by two openings 105, 106 which are formed at an upper face of the waveguide tube 104.

The heating chamber 102 in the first embodiment is configured to have a rectangular-parallelepiped shape having a horizontally long. The placement plate 107 is configured to cover the entire bottom face of the heating chamber 102. The placement plate 107 is adapted to cover the openings 105, 106, which are the microwave radiating portions, so that the openings 105, 105 are not exposed on the inside of the heating chamber 102. The upper face (placement face) of the placement plate 107 is formed to have a flat surface so that it is easy for a user to take the food in and out from the heating chamber 102, and to wipe the placement plate 107 when the placement plate 107 is dirty. The placement plate 107 in the first embodiment is formed by a material that the microwaves are easier to penetrate, such as a glass or ceramics in order to radiate the microwaves from the openings 105, 106 to the inside of the heating chamber 102.

The waveguide 104 is combined to the heating chamber 102 in a way that a propagation direction of the microwave within the waveguide tube 104 is consistent with a width direction (a lateral direction in FIG. 2) of the heating chamber 102. Also, the waveguide tube 104 and the heating chamber 102 are combined so that an opening center line 108 connecting two centers of the openings 105, 106 is consistent with a center line which includes a center position in a front-back direction of the heating chamber 102 (an up-down direction in (a) of FIG. 2). In this specification, the centers of the openings 105, 106 refer to the positions of the centers of gravity in the plate members forming the respective opening shapes, assuming that these respective opening shapes are formed from the plate members having the same thickness and the same specific gravity. Each of the openings 105, 106 is configured to have an opening shape which is formed by crossing two elongated-rectangular openings (slits) at a center thereof like an X-like form. Each of the openings 105, 106 is arranged in one side area divided by a center axis (a tube axis) 109 so that the openings 105, 106 do not intersect with the tube axis 109 of the wave guide tube 104. The tube axis 109 is parallel to the propagation direction in the waveguide tube 104 when viewed from above the waveguide tube 104. Also, the adjacent openings 105, 106 are arranged to have an interval of about the in-tube wavelength λg (Lambda-g) in the propagation direction of the microwave within the waveguide tube 104. The opening 105, in particular, which is close to the end portion 110 (left-end portion of the waveguide tube 104 shown in FIG. 2) in the propagation direction of the waveguide tube 104, is arranged to have an interval of ¼ the in-tube wavelength λg/4 from the end portion 110 of the waveguide tube 104.

In the heating chamber 102, the left-side wall surface 111 is disposed at a position which has an interval of ½ the in-tube wavelength λg/2 in the propagation direction of the waveguide tube 104 from the opening 105. Also, the right-side wall surface 112 is disposed at a position which has an interval of ½ the in-tube wavelength λg/2 in the propagation direction of the waveguide tube 104 from the opening 106. As a result, in the heating chamber 102 of the first embodiment, the interval between the left-side wall surface 111 and the right-side wall surface 112 (the interval in the propagation direction of the microwave in the waveguide tube 104) is set to have twice (2 λg) the length of the in-tube wavelength (λg). Therefore, in the heating chamber 102 of the first embodiment, a radiation area, which has the interval having twice the length of the in-tube wavelength (λg), is formed. Two openings 105, 106 are placed symmetrically in each side with respect to a center line 113 which divides the heating chamber 102 into a right side area and a left side area when viewed from above the heating chamber 102. The center line 113 dividing the heating chamber 102 into the right side area and the left side area is a center line extending in the front-back direction (a center line orthogonal to the width direction) including a center point of a length in the width direction (the lateral direction in FIG. 2) of the heating chamber 102. Therefore, in the first embodiment, two openings 105, 106 are arranged to be placed symmetrically with respect to the center line 113 as a symmetrically axis.

An in-tube standing wave is generated within the waveguide tube 104. The in-tube standing wave has the in-tube wavelength λg which is decided with an oscillating frequency of the magnetron 103 and a shape of the waveguide tube 104. The in-tube standing wave includes anti-node and node which are repeated each ½ the in-tube wavelength λg/2. It is sure that the node exists at the end portion 110 of the waveguide tube 104. (b) of FIG. 2 illustrates image of the in-tube standing wave generated within the waveguide tube 104. One opening 105 closed to the end portion 110 is placed on the anti-node position because the opening 105 is placed on the position of ¼ the in-tube wavelength λg/4 from the end portion 110 of the waveguide tube 104. Another opening 106 is also placed on the anti-node position because the opening 106 is placed on the position of the in-tube wavelength λg from the opening 105.

Also, the heating chamber 102 includes a back-side wall surface 114 and a top surface as well as the left-side wall surface 111 and the right-side wall surface 112. As shown in FIG. 1, an openable and closable door 116 is provided at front side of the heating chamber 102. The microwaves radiated to the inside of the heating chamber 102 are kept in the heating chamber 102 by the closed door 116.

The microwave heating device of the first embodiment having the above-mentioned structure will be described with respect to the operation.

The microwave radiated from the magnetron 103 becomes an in-tube standing wave within the waveguide tube 104, and the microwaves are radiated from both of the openings 105, 106, which are placed at the anti-node positions of the standing wave, to the inside of the heating chamber 102 as circularly-polarized waves. The circularly-polarized waves will hereinafter be described in detail. The openings 105, 106 radiate the microwaves while rotating the electric field in a circumferential direction around the centers of the openings 105, 106 as an approximate center of the rotation. The microwaves are radiated from the openings 105, 106 to the inside of the heating chamber 102 with the image like circles 117, 118 illustrated in (a) of FIG. 2. The microwaves radiated from the openings 105, 106 irradiate uniformly the circumference thereof. As illustrated with arrows 119, 120 in (b) of FIG. 2, the irradiation direction of the microwaves are an upper direction in principle, and the microwaves spread within the heating chamber with the image like parabolas 121, 122. In an upper area of the heating chamber 102, as illustrated with a broken line 123 in (b) of FIG. 2, the distribution of the radiated microwaves becomes more uniform condition because of the composed microwaves.

Hereinafter, an operation and an effect of the microwave oven 101, which is the microwave heating device according to the first embodiment of the present invention, will be described.

As mentioned above, the microwave oven 101 of the first embodiment includes the heating chamber 102 which houses an object to be heated, the magnetron 103 which generates microwave, the waveguide tube 104 which propagates the microwave, and the openings 105, 106 which radiate the microwaves from the waveguide tube 104 to the inside of the heating chamber 102. The heating chamber 102 includes a radiation area which has about twice the length (2 λg) of the in-tube wavelength (λg) in the propagation direction of the waveguide tube 104. These two openings 105, 106 are formed to have an interval of about the in-tube wavelength λg in the propagation direction of the waveguide tube 104. The openings 105, 106 are symmetrically placed with respect to the center line 113 of the radiation area (refer to (a) of FIG. 2). In the microwave oven 101 of the first embodiment having the above-mentioned structure, since the two openings 105, 106 which are disposed to have the interval of about the in-tube wavelength λg are symmetrically arranged with respect to the center line 113 of the radiation area having about twice the length of the in-tube wavelength, the openings 105, 106 are placed at just an intermediate position between the center of the radiation area and each end of the radiation area, respectively. Also, since these two openings 105, 106 are disposed to have the interval of the in-tube wavelength λg, these openings 105, 106 have a positional relationship that the openings 105, 106 are placed on the same phase of the standing wave at all times. Therefore, the same power of the microwave can be output consistently from the inside of the waveguide tube 104 to the heating chamber 102 through the openings 105, 106.

As mentioned above, the microwave oven 101 of the first embodiment is adapted to radiate consistently the same power of the microwaves from each of the openings 105, 106 which are placed at just the intermediate position between the center of the radiation area and each end of the radiation area. Therefore, the microwave oven 101 of the first embodiment can radiate uniformly the microwaves with respect to the whole area from end to end of the radiation area, and it becomes possible to heat uniformly the object to be heated without using a driving mechanism.

In the microwave oven 101 of the first embodiment, the radiation area of the microwaves is a space between the left-side wall surface 111 and the right-side wall surface 112 which are faced each other in the heating chamber 102. Each of the openings 105, 106 is formed at just the center position of respective areas which mean the radiation area divided equivalently into two portions from side to side (right and left in (a) of FIG. 2). The microwaves having the same power are radiated consistently from the openings 105, 106, respectively. Therefore, the microwave oven 101 of the first embodiment can radiate uniformly the microwaves with respect to the whole area from end to end of the radiation area, and it becomes possible to heat uniformly the object to be heated without using a driving mechanism.

Also, the microwave oven 101 of the first embodiment is configured that the openings 105, 106 are placed at positions adjacent to anti-node of the standing wave within the waveguide tube 104. Since the anti-node of the standing wave within the waveguide tube 104 has a high electric field, the microwave oven 101 of the first embodiment having the above-mentioned structure can radiate many microwaves from the openings 105, 106 which are placed at the position adjacent to the anti-node of the standing wave, and can supply stably the microwaves from respective openings 105, 106 into the inside of the heating chamber 102. As a result, the microwave oven 101 of the first embodiment can radiate uniformly the microwaves with respect to the whole area from end to end of the radiation area, and it becomes possible to heat uniformly the object to be heated without using a driving mechanism.

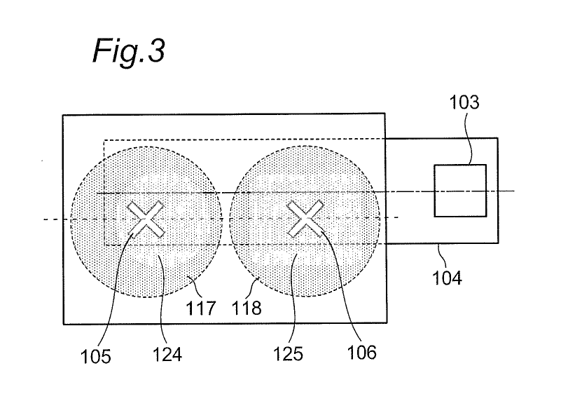

With regard to an object to be heated, although the quality, the shape, the number and how to place etc. are different each time, a heating chamber which has a rectangular-parallelepiped shape having a horizontally long as the microwave oven 101 of the first embodiment, may be capable of heating the most of the object to be heated uniformly, especially, uniformity of heating may be exerted when a plurality of the object to be heated is heated at same time. For example, FIG. 3 is a schematic view showing a positional relationship between foods 124, 125 as a representative object to be heated and openings 105, 106, when viewed from above the heating chamber 102 and the waveguide tube 104 etc. FIG. 3 shows a case that rice 124 as a food and an accompanying dish 125 are heated at same time. In this case, since the heating chamber 102 has an oblong rectangular parallelepiped shape, as shown in FIG. 3, it is most natural to put the rice 124 and the accompanying dish 125 on right and left side by side. Thus, when the rice 124 and the accompanying dish 125 are placed in the heating chamber 102 as mentioned above, each is placed above the opening 105 or 106, respectively. And, the rice 124 is shared by the opening 105, and the accompanying dish 125 is shared by the opening 106, and then these are heated. Therefore, the rice 124 and the accompanying dish 125 which are objects to be heated can be heated more uniformly.

Next, the circular polarization will be described. The circular polarization is a technique which has been widely utilized in the fields of mobile communications and satellite communications, and examples of familiar usages of these communications include ETCs (Electronic Toll Collection Systems) “Non-Stop Automated Fee Collection Systems”. A circularly-polarized wave is a microwave having an electric field with a polarization plane which is rotated, with time, with respect to the direction of radio-wave propagation. When such a circularly-polarized wave is created, the direction of its electric field continuously changes with time. Therefore, microwave being radiated within the heating chamber 103 exhibit the property of continuously changing in angle of radiation, while having a magnitude of an electric-field intensity being unchanged with time. With a microwave heating device which is adapted to radiate the circular polarization, in comparison with microwave heating using linearly-polarized wave, which has been used in conventional microwave heating device, it would be expected to enable uniform microwave heating on objects to be heated. Particularly, there is a higher tendency of uniform heating in the circumferential direction of such circularly-polarized wave. The circularly-polarized wave is sorted into two types, which are right-handed polarized wave (CW: clockwise) and left-handed polarized wave (CCW: counter clockwise), based on their directions of rotations. However, there is no difference in heating performance between the two types.

In order to radiate the circularly-polarized wave, there is a structure which is composed of openings at a wall of the waveguide tube as disclosed in Patent Literatures 1 and 2, and which is composed of a patch antenna as disclosed in Patent Literature 3. In the microwave oven of the first embodiment according to the present invention, the openings 105, 106 are formed at the upper surface (H-plane) of the waveguide tube 104 so as to radiate the circularly-polarized waves, as illustrated in Patent Literature 1.

Since the circular polarization has been mainly used in a communicative field from the first, it is common to be discussed by what is called a progressive wave which is radiated to open space, and does not return as a reflected wave. On the other hand, in the microwave heating device of the first embodiment according to the present invention, the circular polarization is radiated into a closed space which is shielded from the outside by using the waveguide tube 104 and the heating chamber 102. In the waveguide tube 104, a standing wave is produced by compounding a microwave (progressive wave) from the magnetron 103 and a reflected wave which returns to the waveguide tube 104. In the present invention, it is discussing based on the standing wave. However, at the moment of microwave being radiated into the heating chamber 102 from the openings 105, 106, it is thought that the balance of the standing wave in the waveguide tube 104 collapses, and the progressive wave has occurred until it returns to the stable standing wave again in the waveguide tube 104. Therefore, by making the openings 105, 106 into the shape of the circular polarization radiating type, it becomes possible to use the feature of the circular polarization, and can equalize the heating distribution in the heating chamber 102 more.

In order to radiate the circular polarization from the openings 105, 106 prepared on the rectangular waveguide tube 104, two elongated holes (slits) having width are made to intersect at the center of it like the example shown in (a) of FIG. 2, and the openings 105, 106 are arranged in the position where the holes leaned 45 degrees to the microwave propagation direction do not intersect the tube axis 109 of the microwave propagation direction of the waveguide tube 104.

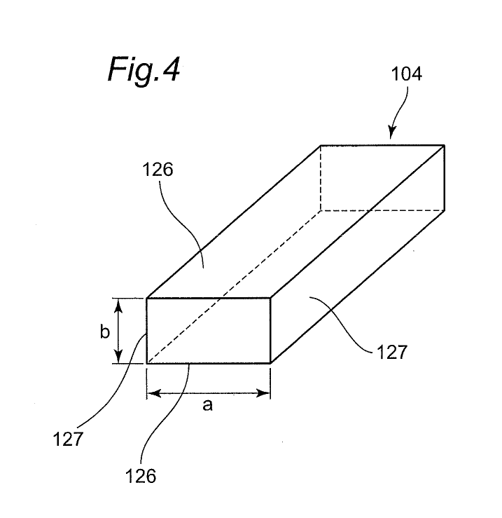

Next, with reference to FIG. 4, there will be described the waveguide tube 104 as a microwave propagation portion. FIG. 4 shows a schematic view illustrating an inside space of a simplest ordinary waveguide tube 104. The simplest ordinary waveguide tube 104 has a rectangular-parallelepiped shape of which the longitudinal direction is the direction of the tube axis. The inside space of the waveguide tube 104 has a rectangular-shaped cross section (width “a”×height “b”) orthogonal to the direction of the tube axis, as illustrated in FIG. 4. In the rectangular waveguide tube formed from this rectangular-parallelepiped member, assuming that the wavelength of microwaves in the free space is λ0 (Lambda-0), the width “a” of the waveguide tube 104 is selected within the range of (λ0>a>λ0/2), and the height “b” of the waveguide tube 104 is selected within the range of (b<λ0/2). By selecting the width “a” and the height “b” of the rectangular waveguide tube 104 as described above, the rectangular waveguide tube 104 is caused to propagate microwaves in the TE10 mode. Such propagating the microwaves with the TE10 has been known.

The TE10 mode refers to a propagation mode with H waves (TE waves; Transverse Electric Waves) having only magnetic-field components while having no electric-field component in the direction of propagation in the waveguide tube 104. Further, other propagation modes than the TE10 mode are hardly employed in the waveguide tube of the microwave heating device.

Next, the wavelength λ0 in the free space will be explained in advance of explanation of the in-tube wavelength λg of the microwave within the waveguide tube 104. In the case of the microwave of a common microwave oven, the wavelength λ0 in the free space is known as about 120 mm. It can ask for the wavelength λ0 in the free space by “λ0=c/f” correctly, wherein, “c” is speed of light and the speed of light is a constant at 3.0×10⁸ [m/s], and “f” is frequency and has width of 2.4-2.5 [GHz] (ISM band). In a magnetron which is a microwave generating portion, since the oscillating frequency “f” changes due to variation or load conditions, the wavelength λ0 in the free space also changes after all, and the wavelength λ0 changes within the ranges from a minimum of 120 [mm] (at 2.5 GHz) to a maximum of 125 [mm] (at 2.4 GHz).

Return to the explanation of the waveguide tube 104, in view of the range of the wavelength λ0 in the free space, in general case, the width “a” of the waveguide tube 104 is selected from the range 80-100 mm, and the height “b” thereof is selected from the range 15-40 mm in many cases. In the waveguide tube 104 shown in FIG. 4, the up-and-down broad side surfaces are called “H-plane” 126 which means faces where magnetic fields are swirled in parallel, and the right-left narrow side surfaces are called “E-plane” 127 which means faces parallel to the electric field. In addition, a wavelength is expressed as the in-tube wavelength λg (Lambda-g) when microwave is transmitted within the waveguide tube 104. The in-tube wavelength λg is expressed in the following equation;

λg=λ₀/√(1−(λ₀/(2×a))²).

The in-tube wavelength λg changes due to the width “a” of the waveguide tube 104, but it is decided regardless of the height “b”. Incidentally, in the TE10 mode, an electric field becomes 0 at the both ends (E-plane) 127 in the width direction (a direction orthogonal to the microwave propagation direction) of the waveguide tube 104, and an electric field becomes the maximum at the center (on the tube axis 109 illustrated in FIG. 2) in the width direction. Therefore, the magnetron 103 is combined to the center (on the tube axis 109) in the width direction of the waveguide tube 104 that the electric field becomes the maximum.

In the structure of the microwave oven of the first embodiment, incidentally, as shown in (a) of FIG. 2, the openings 105, 106 for radiating the circular polarization are formed by elongated holes intersected perpendicularly so that each opening has an X-like form. The openings 105, 106 are configured to generate the circular polarization by that the openings 105, 106 are formed on only one side (lower side in (a) of FIG. 2) from the center in the width direction in H-plane (upper surface) of the waveguide tube 104. The opening for radiating the circular polarization is classified into the right-hand polarization or the left-hand polarization by which the opening is arranged to the center (on the tube axis 109) in the width direction of H-plane of the waveguide tube 104.

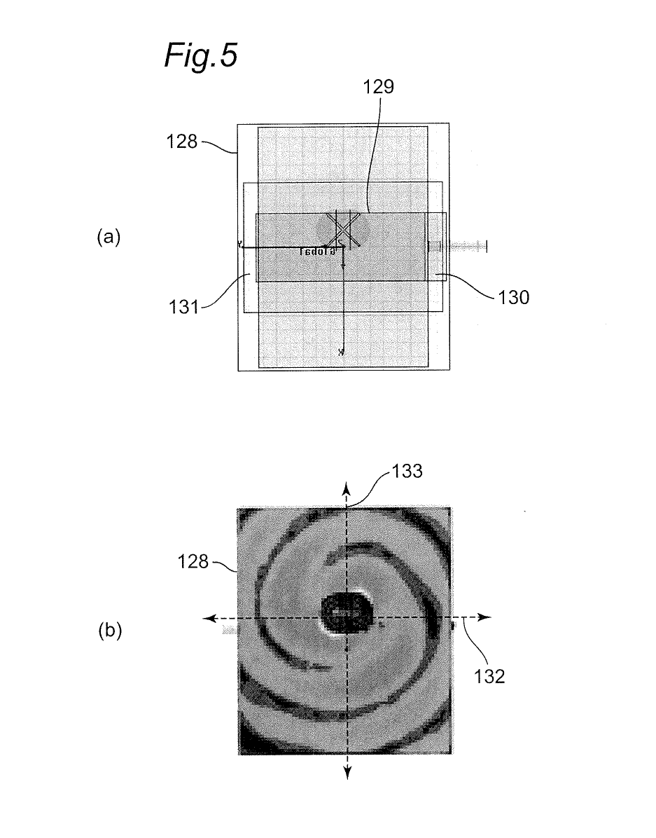

Hereinafter, the feature of the opening having the X-like form which radiates the circular polarization is explained. FIG. 5 shows a simulation result. Since the simulation result shown in FIG. 5 was a simulation, all the surface of walls of the heating chamber 128 are set as a radiation boundary (boundary condition that microwave does not reflect) unlike the actual condition. Also, the simulation was carried out in an easy composition that only one opening 129 was formed in a waveguide tube 130. Moreover, also the end portion 131 of the waveguide tube 130 was set as the radiation boundary (boundary condition that microwave does not reflect). (a) of FIG. 5 shows model geometry when viewed from above the simulation model. (b) of FIG. 5 shows an analysis result, and is a Contour figure of a plane section showing the field intensity distribution within the heating chamber 128 when viewed from above the heating chamber 128. As shown in (b) of FIG. 5, the electric field within the heating chamber 128 is whirling and the circular polarization is produced in the heating chamber 128. The electric field distributions in the propagation direction 132 (the lateral direction of (b) in FIG. 5) of the waveguide tube 130 and the width direction 133 (the up-down direction of (b) in FIG. 5) of the waveguide tube 130 are equal focusing on the opening 129.

Here, in a telecommunication field of the open space and a field of heating of the closed space, since there is a partly different point, explanation about the different point is added. In the telecommunication field, since it would like to avoid mixture with other microwave, and to transmit and receive only required information, the transmitting side will be limited and transmitted to either the right-hand polarization or the left-hand polarization, and an optimal receiving antenna will be chosen by the receiving side in accordance with the transmitted polarization. On the other hand, in the field of heating, in order that an object to be heated, such as food which does not have directivity especially instead of the receiving antenna which has directivity, may receive microwave, it is important only that microwaves hit a whole portion of the object to be heated equally. Therefore, in the field of heating, even if the right-hand polarization and the left-hand polarization are intermingled, it is satisfactory, but it is necessary to prevent becoming unequal distribution with a placement position and a shape of the object to be heated as much as possible. For example, in the structure of the simulation of FIG. 5, only single the opening 129 is formed as a microwave radiating portion. In this case of FIG. 5, it is good to place the object to be heated just above the opening 129. However, if the object to be heated is placed to be shifted from the opening 129 in a front-back direction or a right-left direction of the heating chamber 128, a part surely near the opening 129 will be easy to be heated, and a part far from the opening 129 will be hard to be heated. As a result, heating unevenness will be produced in the object to be heated. For this reason, it is more desirable to prepare two or more openings for radiating the circular polarization. In the microwave oven of the first embodiment, as shown in FIG. 2, the two openings 105, 106 are symmetrically arranged with sufficient balance to the heating area of the heating chamber 102.

With the structure as mentioned above, the microwave oven 101 of the first embodiment is configured that the two openings 105, 106 radiate the circular polarization to the heating area in the heating chamber 102. Since the microwave oven 101 of the first embodiment is structured in this way, as is clear also from the simulation result of FIG. 5, the microwave oven 101 can produce the electric field which rotates in all the 360-degree directions peculiar to the circular polarization focusing on the openings 105, 106. The microwave is radiated in the heating chamber 102 so that the microwave is whirl around from the center, and the portion of the circumferential direction in the heating chamber 102 can be heated uniformly. As a result, the microwaves can be uniformly radiated to the whole heating area of the heating chamber 102, and the object to be heated can be heated uniformly.

Moreover, in the microwave oven 101 of the first embodiment, the openings 105, 106 which radiate the circular polarization are structured by the approximate X-like form which two elongated holes (slits) intersect. Therefore, in the structure of the first embodiment, the microwave oven 101 has the structure that the circular polarization can be certainly radiated from the waveguide tube 104 with easy composition.

In addition, it explained in the microwave oven 101 of the first embodiment that the two openings 105, 106 are arranged symmetrically in the space as a radiation area between the left-side wall surface 111 and the right-side wall surface 112 of the heating chamber 102. The meaning of arranging symmetrically in the present invention does not mean that it is completely in agreement and arranges, without being out of order 1 mm, and this meaning permits a certain amount of range. Since the microwaves radiated to the radiation area in the heating chamber 102 have the wavelength λ0 in the free space, if each of the openings 105, 106 is arranged to have a gap within about ⅛ the wavelength λ0 in the free space, the gap within ⅛ the wavelength λ0 is within the tolerance level without a big change. In case that the microwave is considered as a sine wave, though the maximum or the minimum value is indicated when the opening is arranged at the correct position, “0” is indicated when the opening is arranged to have a gap of ¼ the wavelength from the correct position. Also, though “0” is indicated when the opening is arranged at the correct position, the maximum or the minimum value is indicated when the opening is arranged to have a gap ¼ the wavelength from the correct position. Therefore, if the opening is arranged to have a gap of ¼ the wavelength from the correct position, it will become a big change between the arrangements of the correct position and ¼ the wavelength shifted position. However, in case that the opening is arranged to have a gap of ⅛ the wavelength from the correct position, that is equivalent to the half of ¼ the wavelength, most of magnitude difference between the arrangements of the correct position and ⅛ the wavelength shifted position cannot be found and the same tendency between the correct position and ⅛ the wavelength shifted position can be maintained. For example, the wavelength λ0 in the free space is 120-125 mm as mentioned above, and ⅛ the wavelength λ0 is 15-15.625 mm. Therefore, in case based on the case where the openings 105, 106 are arranged in the completely symmetrical position to the center line of the space (radiation area) between the left-side wall surface 111 and the right-side wall surface 112 in the heating chamber 102, a tolerance level in a leftward or a rightward of respective direction of FIG. 2 can include until a gap of ⅛ the wavelength λ0 in the free space. Concretely, the tolerance level of the gap is 15-15.625 mm.

In the structure of the first embodiment, there has been described an example where the two openings 105, 106 are arranged to have the interval of the in-tube wavelength λg in the propagation direction. The interval of the in-tube wavelength λg permits a certain amount of range. Since the microwave in the waveguide tube 104 has the in-tube wavelength λg, the gap of ⅛ the in-tube wavelength λg is within the tolerance level without a big change. Because, if the opening is arranged to be shifted ¼ the wavelength from the correct position in case that the microwave is considered as a sine wave, the maximum or the minimum value when the opening is arranged at the correct position will change to 0 (zero value) when the opening is arranged to be shifted ¼ the wavelength, and 0 (zero value) when the opening is arranged at the correct position will change to the maximum or the minimum value when the opening is arranged to be shifted ¼ the wavelength. Therefore it will become a big change. However, in case that the opening is arranged to be shifted ⅛ the wavelength which is equivalent to the half of ¼ the wavelength, most of magnitude difference between the arrangements of the correct position and ⅛ the wavelength shifted position cannot be found and the same tendency will be maintained. For example, the in-tube wavelength λg is expressed in the following equation;

λg=λ₀/√(1−(λ₀/(2×a))²).

The wavelength λ0 in the free space is 120-125 mm as mentioned above, and ⅛ the wavelength λ0 is 15-15.625 mm. In case that the width “a” of the waveguide tube 104 in the first embodiment is 100 mm (a=100 mm), the in-tube wavelength λg is set from 150 mm (at 2.5 GHz) to 160 mm (at 2.4 GHz), and ⅛ the in-tube wavelength λg is 18.75-20 mm. Therefore, in case based on the case where the openings 105, 106 are arranged to have an interval having only the in-tube wavelength λg (150-160 mm), a tolerance level of the interval between the opening 105 and the opening 106 in the propagation direction of the waveguide 104 can include until the gap of ⅛ the in-tube wavelength λg. Concretely, the tolerance level of the gap is 18.75-20 mm. For this reason, the interval between the opening 105 and the opening 106 in the propagation direction of the waveguide tube 104 will be a minimum of 131.25 mm to a maximum of 180 mm in view of the tolerance level of the gap.

In the first embodiment, when discussing the interval between the openings with respect to the propagation direction of the waveguide tube 104, only the propagation direction component having the shortest distance in a straight line which connects the center of each opening 105, 106 along the wall surface (surface facing to the bottom of the heating chamber) of the waveguide tube 104 shall be considered. As mentioned above, the centers of the openings 105, 106 refer to the positions of the centers of gravity in the plate members forming the respective opening shapes, assuming that these respective opening shapes are formed from the plate members having the same thickness and the same specific gravity.

In the first embodiment, there has been described an example where the heating chamber 102 has the radiation area of which the length in the propagation direction of the waveguide tube 104 is twice the length (2 λg) of the in-tube wavelength. The twice the length of the in-tube wavelength permits a certain amount of range. Since the microwave propagated to the radiation area becomes a microwave having the wavelength λ0 in the free space, if the opening is arranged to be shifted about ⅛ the wavelength λ0 in the free space, it is considered to be tolerance level without a big change. Because, if the opening is arranged to be shifted ¼ the wavelength from the correct position in case that the microwave is considered as a sine wave, the maximum or the minimum value when the opening is arranged at the correct position will change to 0 (zero value) when the opening is arranged to be shifted ¼ the wavelength, and 0 (zero value) when the opening is arranged at the correct position will change to the maximum or the minimum value when the opening is arranged to be shifted ¼ the wavelength. Therefore it will become a big change. However, in case that the opening is arranged to be shifted ⅛ the wavelength which is equivalent to the half of ¼ the wavelength, most of magnitude difference between the arrangements of the correct position and ⅛ the wavelength shifted position cannot be found and the same tendency will be maintained. For example, the wavelength λ0 in the free space is 120-125 mm as mentioned above, and ⅛ the wavelength λ0 is 15-15.625 mm. Therefore, in case based on the case where the interval between the left-side wall surface 111 and the right-side wall surface 112 is set to just twice the length (300-320 mm) of the in-tube wavelength a, a tolerance level of the interval between the left-side wall surface 111 and the right-side wall surface 112 can include until the gap of ⅛ the wavelength λ0 in the free space. Concretely, the tolerance level of the gap is 15-15.625 mm. Therefore, the interval between the right-side wall surface 111 and the left-side wall surface wall 112 in the heating chamber 102 will be a minimum of 285 mm to a maximum of 335.625 mm in view of the tolerance level of the gap.

In the first embodiment, there has been described an example where the openings 105, 106 are formed at the positions of the anti-node of the standing wave in the waveguide tube 104, respectively. The position of the anti-node permits a certain amount of range. Since the microwave in the waveguide tube 104 has the in-tube wavelength λg, if the opening is arranged to be shifted about ⅛ the in-tube wavelength λg, it is considered to be within the tolerance level without a big change. Because, if the opening is arranged to be shifted ¼ the wavelength from the correct position in case that the microwave is considered as a sine wave, the maximum or the minimum value when the opening is arranged at the correct position will change to 0 (zero value) when the opening is arranged to be shifted ¼ the wavelength, and 0 (zero value) when the opening is arranged at the correct position will change to the maximum or the minimum value when the opening is arranged to be shifted ¼ the wavelength. Therefore it will become a big change. However, in case that the opening is arranged to be shifted ⅛ the wavelength which is equivalent to the half of ¼ the wavelength, most of magnitude difference between the arrangements of the correct position and ⅛ the wavelength shifted position cannot be found and the same tendency will be maintained. For example, the in-tube wavelength λg is expressed in the following equation;

λg=λ₀/√(1−(λ₀/(2×a))²).

The wavelength λ0 in the free space is 120-125 mm as mentioned above. In case that the width “a” of the waveguide tube 104 in the first embodiment is 100 mm (a=100 mm), the in-tube wavelength λg is set from 150 mm (at 2.5 GHz) to 160 mm (at 2.4 GHz), and ⅛ the in-tube wavelength λg is 18.75-20 mm. Therefore, in case base on the position of the just anti-node, a tolerance level of the interval of the opening 105 and the opening 106 in the propagation direction of the waveguide tube 104 can include until the gap of ⅛ the in-tube wavelength λg. Concretely, the tolerance level of the gap in the propagation direction of the waveguide tube 104 of the opening 105 and the opening 106 is 18.75-20 mm.

In the first embodiment, there has been described an example where the heating chamber 102 is formed into a rectangular parallelepiped shape, each of the left-side wall surface 111 and the right-side wall surface 112 has a flat surface, and the radiation area is configured that the interval between the left-side wall surface 111 and the right-side wall surface 112 has twice the length (2 λg) of the in-tube wavelength. The present invention may include a case that the wall surface is formed to have unevenness in the middle portion instead of the flat surface of the wall. In this case, the interval between the right-side wall surface 111 and the left-side wall surface 112 should be determined, except for unevenness, especially, with the lowest position of the right side wall surface 111 and the left-side wall surface wall 112, i.e., at the position of the upper surface of the placement plate 107. Discussing the interval between the right-side wall surface 111 and the left-side wall surface 112 in this position, it is the most suitable position for arguing the distance about distribution of microwave. Because it means a position immediately after the microwave is radiated within the heating chamber and that the height of this position where an object to be heated is actually positioned.

### Second Embodiment

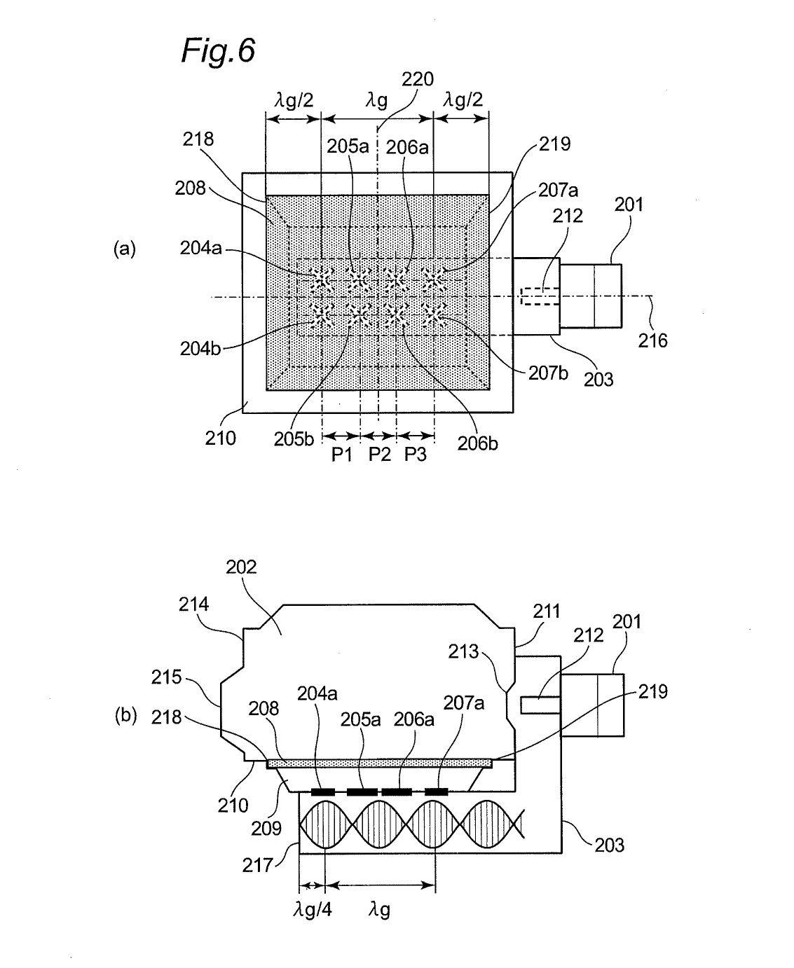

Hereinafter, a microwave heating device according to a second embodiment of the present invention will be described, with reference to drawings. FIG. 6 is diagrams explaining structures of principal components in a microwave oven as the microwave heating device according to the second embodiment of the present invention. FIG. 6 shows schematic views of a microwave generating portion, a waveguide tube, a heating chamber and the like. In FIG. 6, (a) is a sectional plan-view when viewed from above the heating chamber and the like. Also, (b) is a sectional front-view when viewed from front side of the heating chamber and the like. The microwave oven as the microwave heating device of the second embodiment will be described focusing on difference points from the first embodiment. In the following description of the second embodiment, components having the same functions and structures as those of the components of the microwave heating device according to the first embodiment will be designated by the same reference characters, and omit the explanation of them.

The microwave oven as the microwave heating device of the second embodiment includes a waveguide 203 which is bent in the shape of an L-like form (refer to (b) of FIG. 6) and which leads the microwave radiated from the magnetron 201 as a microwave generating portion to the heating chamber 202; a plurality of openings 204a, 204b, 205a, 205b, 206a, 206b, 207a, 207b (hereinafter, abbreviated to 204a-207b) as microwave radiating portions which radiates the microwave in the waveguide tube 203 to the inside of the heating chamber 202; and placement plate 208 for placing the food (not shown) as an object to be heated. The plurality of openings 204a-207b as the microwave radiating portions is formed on the upper surface of the waveguide tube 203.

A bottom space 209 formed under the heating chamber 202 is provided in order to secure a fixed distance between a plane disposing the openings 204a-207b formed on the upper surface of the waveguide tube 203, and the placement plate 208 which is the substantial bottom of the heating chamber 202. The bottom space 209 makes a center portion of the bottom face 210 of the heating chamber 202 project downwardly so that a lower part of the bottom space 209 is formed to be narrow by slanted side surfaces. The undersurface of the bottom space 209 is formed by the upper faces of the waveguide tube 203, and the upper surface of the bottom space 209 is formed by the under face of the placement plate 208. The placement plate 208 is fixed to the outside portions of the bottom face 210 in the heating chamber 202 by using putty, packing and the like so that the openings 204a-207b are exposed on the heating chamber 202.

In the heating chamber 202 of the microwave oven of the second embodiment, as shown in (a) of FIG. 6, the placement plate 208 is configured to be a little smaller than the bottom face 210 of the heating chamber 202. Moreover, the right-side wall surface 211 of the heating chamber 202 is formed to be integrated with the waveguide tube 203. The right-side wall surface 211 has a convex part 213 in order to secure insulation distance with a radiation antenna 212 (output end) of the magnetron 201. Furthermore, as shown in (b) of FIG. 6, the left-side wall surface 214 of the heating chamber 202 has a concavo-convex shape, such as a convex part 215 projecting outward. Therefore, the heating chamber 202 of the microwave heating device of the second embodiment is configured to have a shape that the right-side wall surface 211 and the left-side wall surface 214 are not symmetrical.

In the microwave oven of the second embodiment, as shown in (a) of FIG. 6, every two of the plurality of the openings 204a-207b are arranged side by side in the width direction of the waveguide tube 203, and every four are arranged a line along with the tube axis 216 which is the center axis of the waveguide tube 203. Namely, in the structure of the microwave heating device of the second embodiment, every four the openings 204a, 205a, 206a, 207a, and the openings 204b, 205b, 206b, 207b are symmetrically arranged along with a line at both sides of the tube axis 216 of the waveguide tube 203, respectively.

The position of the tube axis 216 of the waveguide tube 203 is consistent with the center line including the center in the front-back direction of the bottom face 210 of the heating chamber 202 and the center in the front-back direction of the placement plate 208 of the heating chamber 202. Thereby, the openings 204a-207b becomes symmetrical arrangement to the center line (tube axis 216) extending in the width direction (the lateral direction) of the bottom face 210 of the heating chamber 202 and the placement plate 208. Moreover, the openings 204a-207b are formed to have opening shapes which can radiate the circular polarization with the X-like forms each of which is shaped by two elongated holes (slits) intersected with each other. In the planar view, the openings 204a-207b are arranged not to intersect the tube axis 216 of the waveguide tube 203.

Furthermore, with regard to the openings 204a, 204b and the openings 207a, 207b which are placed at the both end sides of the waveguide tube 203 in the propagation direction, each interval between the centers of the opening positions 204a, 207a and the center positions of the openings 204b, 207b are formed to have an interval of about the in-tube wavelength λg (Lambda g) in the propagation direction of the waveguide tube 203. With regard to the openings 204a, 204b which are positioned at the nearest to the end portion 217 of the waveguide tube 203, especially, the center positions of the openings 204a, 204b are arranged to have an interval of ¼ λg in the propagation direction of the waveguide tube 203 from the end portion 217 of the waveguide tube 203.

The left-side end 218 of the placement plate 208 is arranged to have an interval of the ½ λg in a lateral direction (a width direction) of the placement plate 208 from the center positions of the openings 204a, 204b. Also, the right-side end 219 of the placement plate 208 is arranged to have an interval of the ½ λg in the lateral direction (the width direction) of the placement plate 208 from the center positions of the openings 207a, 207b. As a result, the placement plate 208 has a radiation area which has twice the length (2 λg) of the in-tube wavelength in the propagation direction of the waveguide tube 203.

In the microwave oven of the second embodiment, as shown in (a) of FIG. 6, “P1” means an interval between the center positions of the left-end openings 204a, 204b and the center positions of the 2nd opening 205a, 205b from the left-end side in the width direction (the lateral direction) of the heating chamber 202. “P2” means an interval between the center positions of the 2nd openings 205a, 205b from the left-end side and the center positions of the 2nd opening 206a, 206b from the right-end side in the width direction (the lateral direction) of the heating chamber 202. And, “P3” means an interval between the center positions of the 2nd openings 206a, 206b from the right-end side and the center positions of the right-end opening 207a, 207b in the width direction (the lateral direction) of the heating chamber 202. These “P1”, “P2” and “P3” have P1=P3>λg/3, and P2<λg/3, and these openings 204a-207b are configured to have the following relations.

The left-end openings 204a, 204b and the right-end openings 207a, 207b have the completely same shape, and the 2nd openings 205a, 205b from the left-end side and the 2nd openings 206a, 206b have also the completely same shape. And further, these 2nd openings 205a, 205b, 206a, 206b are formed to have more wide width of the intersected elongated hole (slit) than the width of the intersected elongated hole (slit) of the left-end and right-end openings 204a, 204b, 207a, 207b.

The openings 204a-207b formed as mentioned above are arranged to have symmetrical positions and shapes to the center line 220 (refer to (a) of FIG. 6) of the width direction of the placement plate 208. The in-tube standing wave is produced in the waveguide tube 203, and repeats an anti-node and a node for every ½ the in-tube wavelength λg. Therefore, at the end portion 217 of the waveguide tube 203, it certainly becomes a node of the in-tube wavelength λg. Since the centers of the left-end openings 204a, 204b are positioned to have the interval of ¼ the in-tube wavelength λg from the end portion 217 of the waveguide tube 203, the anti-node of the in-tube wavelength λg arises at these positions of the left-end openings 204a, 204b. Also, since the centers of the right-end openings 207a, 207b are positioned to have the interval of the in-tube wavelength λg from the centers of the left-end openings 204, respectively, the anti-node of the in-tube wavelength λg arises at these positions of the right-end openings 207a, 207b too. However, the 2nd opening 205a, 205b from the left-end side and the 2nd opening 206a, 206b from the right-end side, as shown in the image drawing of the inside of the waveguide tube 203, are arranged at an intermediate position between the anti-node and the node of the in-tube wavelength λg.

The microwave oven that is the microwave heating device of the second embodiment with the above-mentioned structure will be described with respect to the operation.

The microwave emitted from the magnetron 201 becomes a standing wave within the waveguide tube 203. The microwave as the circular polarization is radiated to the inside of the heating chamber 202 from the openings 204a, 204b, 207a, 207b which are arranged at the anti-node positions of the standing wave, and the openings 205a, 205b, 206a, 206b which are arranged at the position between the anti-node and node. The circular polarization is radiated while rotating an electric field in the direction of the circumference centering on the nearly centers of the openings 204a-207b. The radiated circular polarization is diffused gradually in the bottom space 209 from the opening 204a-207b to the placement plate 218, and then the diffused circular polarization is radiated with a spread on the placement plate 218. As mentioned above, the opening 204a-207b are symmetrically arranged in the front-back direction from end to end of the placement plate 218, and is symmetrically arranged also in the lateral direction from end to end of the placement plate 218. Moreover, the phase of the standing wave within waveguide tube 203 corresponding to the openings 204a-207b is also symmetrically produced. Therefore, the microwave having symmetry is radiated to the object (not shown) to be heated placed on the placement plate 218. As a result, in the microwave oven of the second embodiment, it becomes possible to heat uniformly the object to be heated in the heating chamber 202.

Hereinafter, an operation and an effect of the microwave oven, which is the microwave heating device according to the second embodiment of the present invention, will be described.

The microwave oven of the second embodiment includes the heating chamber 202 which is adapted to house an object to be heated, the magnetron 201 which is adapted to generate the microwaves, the waveguide tube 203 which is adapted to transmit the microwaves, and openings 204a-207b which are adapted to radiate the microwaves from the waveguide tube 203 to the inside of the heating chamber 202, as mentioned above. The heating chamber 202 includes the placement plate 208 having the radiation area which has about twice the length (2 λg) of the in-tube wavelength in the propagation direction of the waveguide tube 203. The openings 204a, 204b and the openings 207a, 207b, which are disposed at the both ends in the propagation direction of the waveguide tube 203, are formed to have the interval of approximate the in-tube wavelength, and are symmetrically arranged with respect to the center line 220 in the width direction (the lateral direction) of the placement plate 208 and the center line (the tube axis 216) in the front-back direction of the placement plate 208. Therefore, the openings 204a, 204b and the openings 207a, 207b, which are disposed at the both ends to have the interval of the in-tube wavelength, are symmetrically arranged with respect to the center line 220 in the width direction (the lateral direction) of the placement plate 208 which has about twice the length (2 λg) of the in-tube wavelength in the propagation direction of the waveguide tube 203. As a result, each of the openings 204a, 204b, 207a, 207b are disposed at just the intermediate position between the center of the placement plate 208 (the center line 220) and each end in the lateral direction of the placement plate 208. Also, since the openings 204a, 204b and the openings 207a, 207b, which are disposed at the both ends in the propagation direction, have the interval of the in-tube wavelength, the openings 204a, 204b and the openings 207a, 207b are configured to have a positional relationship that they are positioned at the same phase every time. The openings 204a, 204b and the openings 207a, 207b can always radiate an equivalent quantity of microwaves towards the heating chamber 202 from the inside of the waveguide tube 203.

As mentioned above, in the microwave oven of the second embodiment, since the equivalent quantity of microwaves can always be radiated from the openings 204a, 204b, 207a, 207b, which are disposed at the just the intermediate position between the center of the placement plate 208 and each end in the lateral direction of the placement plate 208, the microwaves are irradiated uniformly to expose whole area from end to end in the width direction (the lateral direction) of the placement plate 208. Therefore, the object to be heated can be heated uniformly without using a driving mechanism.

In the microwave heating device illustrated as a microwave oven in the second embodiment, the radiation area is explained as the placement plate 208 on which the object to be heated is placed. As mentioned above, by making the radiation area on the placement plate 208, since the equivalent quantity of microwaves can be radiated from each of the openings 204a, 204b, 207a, 207b, which are disposed at the just the intermediate position between the center of the placement plate 208 and each end in the lateral direction of the placement plate 208, respectively. The microwaves can be uniformly radiated to whole area from end to end in the width direction (the lateral direction) of the placement plate 208. Therefore, the microwave heating device is enabled to make uniform microwave heat to the object to be heated, without using a driving mechanism.

In the microwave heating device illustrated as a microwave oven in the second embodiment, the radiation area is explained as the placement plate 208 on which the object to be heated is placed. As mentioned above, by making the radiation area on the placement plate 208, since the equivalent quantity of microwaves can be radiated from each of the openings 204a, 204b, 207a, 207b, which are disposed at the just the intermediate position between the center of the placement plate 208 and each end in the lateral direction of the placement plate 208, respectively. The microwaves can be uniformly radiated to whole area from end to end in the width direction (the lateral direction) of the placement plate 208. Therefore, the microwave heating device is enabled to make uniform microwave heat to the object to be heated, without using a driving mechanism.

The microwave heating device of the second embodiment is configured that the openings 204a, 204b and the openings 207a, 207b, which are disposed at the both ends of the propagation direction of the waveguide tube 203, are arranged near the anti-node of the standing wave in the waveguide tube 203. Since the electric field at the anti-node of the standing wave is strong, the radiant quantities of the microwaves from the openings 204a, 204b, 207a, 207b disposed located near the anti-node can be increased by the structure of the second embodiment. Also, the openings 204a, 204b, 207a, 207b can supply stable microwaves to the inside of the heating chamber. Therefore, in the microwave heating device of the second embodiment, an object to be heated can be heated uniformly, and the microwaves can be uniformly radiated to whole area from end to end of the radiation area as intended. As a result, the object to be heated can be heated uniformly without using a driving mechanism.

The microwave heating device of the second embodiment is configured that the openings 205a, 205b and the openings 206a, 206b, are formed as other microwave radiating portions between the openings 204a, 204b and the openings 207a, 207b which are arranged at the both ends in the propagation direction. For example, in case that a waveguide tube that the in-tube wavelength becomes long is chosen, the respective interval between the openings 204a, 204b and the openings 207a, 207b arranged at the both ends in the propagation direction becomes a long distance (the radiation area also becoming large), respectively. In this case, there is fear that it is hard to heat just a middle portion between the openings 204a, 204b and the openings 207a, 207b arranged on both ends, because this middle portion is far from these both-end openings 204a, 204b, 207a, 207b. However, by forming other openings 205a, 205b and the openings 206a, 206b between the openings 204a, 204b and the openings 207a, 207b, the heating of the middle portion of the heating area can be boosted and it becomes possible to heat uniformly the object to be heated, which is placed on the middle portion. Furthermore, in general, since it has a very high possibility to place an object to be heated on the center portion of the heating chamber 202, the microwave heating device of the second embodiment is configured to have more high heating efficiency because of boosting the heating of the middle portion.

Moreover, the microwave heating device of the second embodiment is configured that the openings 204a-207b are arranged to be in juxtaposition every two openings in the width direction of the waveguide tube 203, and are arranged into two rows along the propagation direction of the waveguide tube 203. With the above-mentioned structure, the microwave heating device has a structure that it is easy to diffuse the microwaves in the width direction of the waveguide tube 203 as well as it is steady to heat uniformly the object to be heated along the propagation direction of the waveguide tube 203.

Further, in the microwave heating device of the second embodiment, the openings 204a-207b are adapted to radiate circular polarizations. With the above-mentioned structure, the electric field which rotates in all the 360-degree directions peculiar to the circular polarization centering on each center of openings 204a-207b is generated. The microwaves are radiated so that they may whirl around from each center, and an area in a circumferential direction can be heated uniformly. As a result, the microwaves can be uniformly radiated to the whole heating chamber 202, and an object to be heated can be heated uniformly.

Further, the microwave heating device of the second embodiment is configured that the openings 204a-207b have approximately X-like form that two elongated holes (slits) intersect. With the above-mentioned structure, the circular polarization can be certainly radiated from the waveguide tube 203 with a simple structure.

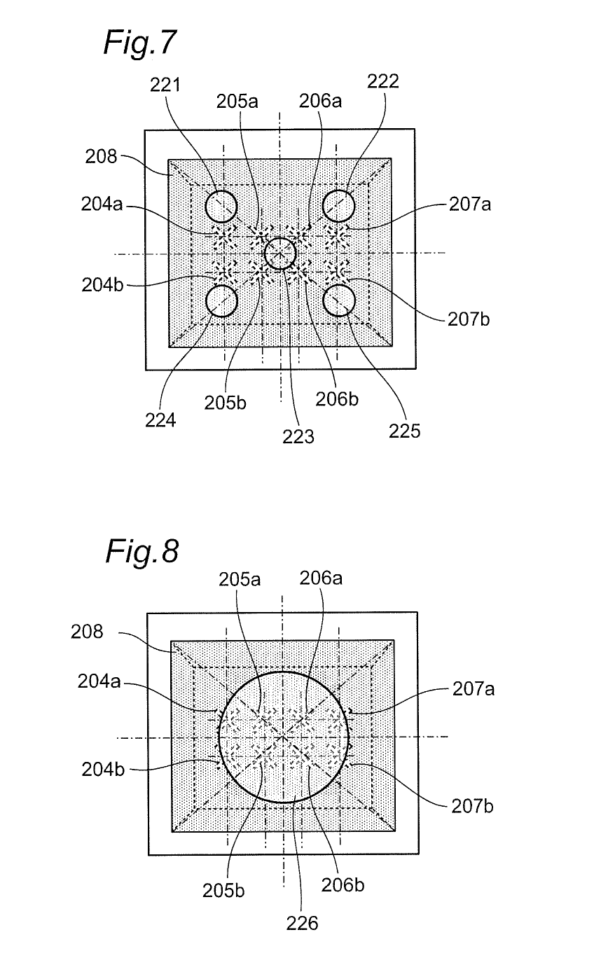

Also, with regard to the object to be heated in the heating chamber, although the quality of the material, the shape, the number and how to place etc. differ from every time, and it is not generally decided, it becomes possible to heat uniformly most of the object to be heated by preparing many openings as the microwave radiating portions like the second embodiment, and arranging the object to be heated in balance. Furthermore, it is also possible to optimize an opening in order to heat more uniformly to a specific object to be heated. For example, there is a method well used for evaluation of the heating distribution in China now. It is a method based on regulation of IEC (International Electrotechnical Commission) from the first, the valuation method using the water included in five beakers as an object to be heated is known. Arrangement of five beakers used in this valuation method is shown in FIG. 7. The to-be-heated objects 221, 222, 223, 224, 225 shown in FIG. 7 put 100 cc water into beakers, respectively. A regulation of how to place the beakers provides that five beakers are disposed at following positions; in a supposition that diagonal lines are drawn from the corner of an upper surface of a placement plate having a rectangular shape, one beaker (to-be-heated object 223) is disposed at the center, and remain four beakers (to-be-heated objects 221, 222, 224, 225) are disposed at positions on the diagonal lines. The four breakers are disposed at the divided points of the diagonal lines each of which is equally divided into four. If the regulation is applied to the placement plate 208 of the second embodiment, five beakers are arranged on the diagonal lines as shown in FIG. 7. In China, each rise of the temperatures of the objects to be heated is measured when the objects are heated, and score evaluation of the heating distribution is carried out based on the measured values. It is necessary to rise equally the temperatures of the five to-be-heated objects 221, 222, 223, 224, 225, in order to evaluate well. For this reason, in the structure of the second embodiment, the to-be-heated object 221 is heated by the left-back side opening 204a, the to-be-heated object 224 is heated by the left-front side opening 204b, the to-be-heated object 222 is heated by the right-back side opening 207a, and the to-be-heated object 225 is heated by the right-front opening 207b. The to-be-heated object 223 is heated by the residual four openings 205a, 205b, 206a, 206b in the center portion.

As mentioned above, in the structure of the second embodiment, the openings 204a, 204b, 205a, 205b, 206a, 206b, 207a, 207b are adapted to heat equally each of the to-be-heated objects 221, 222, 223, 224, 225. For the purpose, it is possible to apply a method of adjusting the opening shape, a method of adjusting the length of the width direction of the waveguide tube 203 and changing the position of the openings 204a, 204b, 207a, 207b, and a method of changing the shape of the placement plate 208 according to the shape of the waveguide tube 203. As easiest method, each of the back-left side opening 204a, the left-front side opening 204b, the right-back side opening 207a and the right-front side opening 207b is designed so that it may be arranged just under the to-be-heated object 221, 224, 222, or 225. In order to design in this way, it is easily realizable by expanding the width of the waveguide tube 203 so as to extend the pitch between the openings in the width direction of the waveguide tube 203, or by shortening the length in the front-back direction of the placement plate 208 so as to narrow the placement plate 208. And then, it is possible to adjust and optimize shapes, positions, etc. of the openings 205a, 205b, 206a, 206b in the center portion by comparing the rise of temperature of the center to-be-heated object 223 which is heated mainly by the openings 205a, 205b, 206a, 206b in the center portion, with the rise of temperature of other to-be-heated objects 221, 224, 222, 225.

In China, there is a standard about evaluation of energy saving besides the evaluation of the heating distribution. The object to be heated, which is used in the evaluation of the energy saving, is the object 226 to be heated as shown in FIG. 8. And the water of 1 L put into a container having large base area is used as the object to be heated according to the regulation of IEC. In this case, it is decided that the object 226 to be heated is arranged at the center of the placement plate 208. Since the energy saving is evaluated based on the heating efficiency, the energy saving must improve heating efficiency as much as possible, in order to save energy well. In the case that an opening as a microwave radiating portion is used like the structure of the second embodiment, it is advantageous that a structure carries out direct irradiation of the microwave from an opening to an object to be heated. Because if the microwave is diffused within the heating chamber without carrying out the direct irradiation of the microwave to an object to be heated, the number of times of reflection within the heating chamber increases, and a wall-surface loss within the heating chamber and a rate absorbed by the placement plate become large value. As a result, it is thought that the quantity of the microwave absorbed by an object to be heated decreases. Therefore, it is desirable to arrange the openings 204a-207b just under the object 226 to be heated as much as possible. In the structure of the second embodiment, since almost all the openings 204a-207b are formed just under the object 226 to be heated, it is very advantageous to energy saving. Of course, if the openings 204a, 204b and the openings 207a, 207b, which are placed at the both ends in the propagation direction of the waveguide tube 203, are formed to have more small shapes, or if the waveguide tube 203 is formed to have more wide width so as to shorten the above-mentioned in-tube waveguide λg, and then the openings 204a, 204b and the openings 207a, 207b, which are placed at the both end sides, are arranged to approach inside more, the microwave heating device is configured to have a heating structure with high efficiency in which energy saving can be aimed more. When such a change is carried out, the influence on heating distribution may be going to be worrisome. However, in the structure of the second embodiment, in case of shortening the intervals between the openings 204a, 204b and the openings 207a, 207b placed at the both ends in the propagation direction, it is only necessary to narrow the width of the placement plate 208 in the width direction (the lateral direction). With the above-mentioned structure, it is possible to make compatible the energy saving explained with FIG. 7 and the heating distribution explained with FIG. 8.

Also, although the placement plate 208 composes the radiation area somewhat narrower than distance between the left-side wall surface 214 and the right-side wall surface 211 of the heating chamber 202 in the second embodiment, the present invention is not limited to such structure. As shown in (b) of FIG. 2 of the above-mentioned first embodiment, it can also choose a structure that both side ends of the placement place (107) corresponds with the right-side and left-side wall surfaces (111, 112) on either side. Anyway, in the case that the placement plate 208 composes a radiation area, it has the effect that the design for securing the distribution performance of five beakers in China standard becomes easy, as above-mentioned. As a design manual, it becomes possible to adjust heating distribution of other area finely by using structures and shapes (unevenness) of the wall surfaces of the heating chamber 202, with securing the heating distribution performance of five beakers by the shape of the placement plate 208. Also, in the present invention, it is able to improve heating distribution of various areas in the radiation area simultaneously, and it is effective in a design becoming easy.

### Third Embodiment

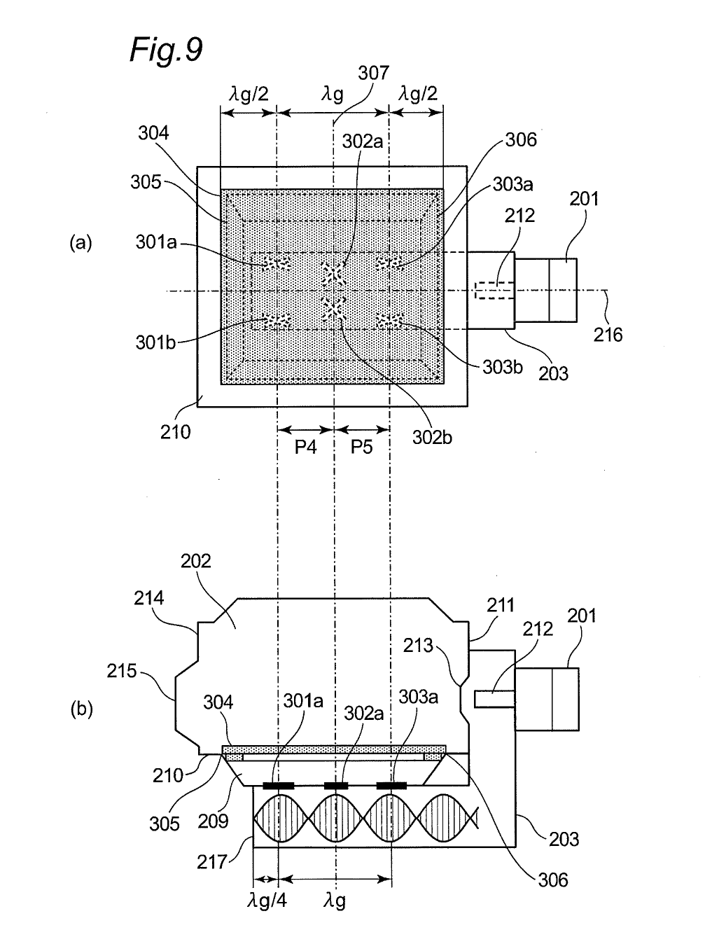

Hereinafter, a microwave heating device according to a third embodiment of the present invention will be described, with reference to drawings. FIG. 9 is diagrams explaining structures of principal components in a microwave oven as the microwave heating device according to the third embodiment of the present invention. FIG. 9 shows schematic views of a microwave generating portion, a waveguide tube, a heating chamber and the like. In FIG. 9, (a) is a sectional plan-view when viewed from above the heating chamber and the like. Also, (b) is a sectional front-view when viewed from front side of the heating chamber and the like. The microwave oven as the microwave heating device of the third embodiment will be described focusing on difference points from the first embodiment and the second embodiment. In the following description of the third embodiment, components having the same functions and structures as those of the components of the microwave heating device according to the first embodiment and the second embodiment will be designated by the same reference characters, and omit the explanation of them.

In structure of the third embodiment, different points from the structure of the second embodiment are that six openings are prepared and structure of openings differs from the openings of the second embodiment. Moreover, in the third embodiment, structure of a placement plate, on which an object to be heated is placed, and which is adapted to be detachable freely, differs from the structure of the second embodiment.

In the microwave oven of the third embodiment, as shown in (a) of FIG. 9, every two of a plurality of openings 301a, 301b, 302a, 302b, 303a, 303b are arranged side by side in the width direction (the up-down direction in (a) of FIG. 9) of the waveguide tube 203. And every three are arranged in the both sides of the tube axis 216 which is the center axis of the waveguide tube 203. In the structure of the microwave oven according to the third embodiment, every three openings 301a, 302a, 303a and 301b, 302b, 303b are symmetrically arranged in the both sides of the tube axis 216 of the waveguide tube 203 with respect to the tube axis 216. That is, in the propagation direction (lateral direction in (a) of FIG. 9) of the waveguide tube 203, the center of the opening 301a and the center of the opening 301b are established at the same position, and are arranged to have the same distance from the tube axis 216 of the waveguide tube 203. Similarly, the position of the center of the opening 302a and the center of the opening 302b, and the position of the center of the opening 303a and the center of the opening 303b are the same positions in the propagation direction of the waveguide tube 203. Also, the center of the opening 302a and the center of the opening 302b are arranged to have the same distance from the tube axis 216 of the waveguide tube 203, and the center of the opening 303a and the center of the opening 303b are arranged to have the same distance from the tube axis 216 of the waveguide tube 203.

As shown in (a) of FIG. 9, with regard to the openings 301a, 301b nearest to the end portion 217 of the waveguide tube 203, and the openings 303a, 303b nearest to the magnetron 201, the elongated holes (slits) which form each opening 301a, 301b, 303a, 303b does not intersect at right-angled. Also, the angles, which face in the propagation direction in each opening 301a, 301b, 303a, 303b composed of the intersected elongated holes to have an X-like form, are acute angles. That is, each opening 301a, 301b, 303a, 303b has the crushed X-like form having the short length in the width direction of the waveguide tube. Moreover, each opening 301a, 301b, 303a, 303b is arranged at an outside position slid to outside in the width direction (the front-back direction of the heating chamber 202, i.e., the up-down direction in (a) of FIG. 9) of the waveguide tube 203. In the microwave oven of the third embodiment, since the openings 301a, 301b, 303a, 303b are constituted as mentioned above, the microwaves diffused in the front-back direction of the heating chamber 202 are radiated from the openings 301a, 301b, 303a, 303b.

In the propagation direction of the waveguide tube 203, the openings 302a, 302b are arranged in the center of the openings 301a, 301b and the openings 303a, 303b, respectively. The interval P4 between the center position (the center line) of the openings 301a, 301b and the center position (the center line) of the openings 302a, 302b in the propagation direction of the waveguide tube 203 is equal to the interval P5 between the center position of the openings 302a, 302b, and the center position of the openings 303a, 303b, and is λg/2 (P4=P5=λg/2). In the microwave oven as the microwave heating device of the third embodiment having the above-mentioned structure, as shown in (b) of FIG. 9, since the openings 301a, 301b and the openings 303a, 303b are arranged at the positions where anti-node of the in-tube standing wave arises, and the center openings 302a, 302b are also arranged at the positions where anti-node of the in-tube standing wave arises, the radiant quantities of microwaves can be increased.

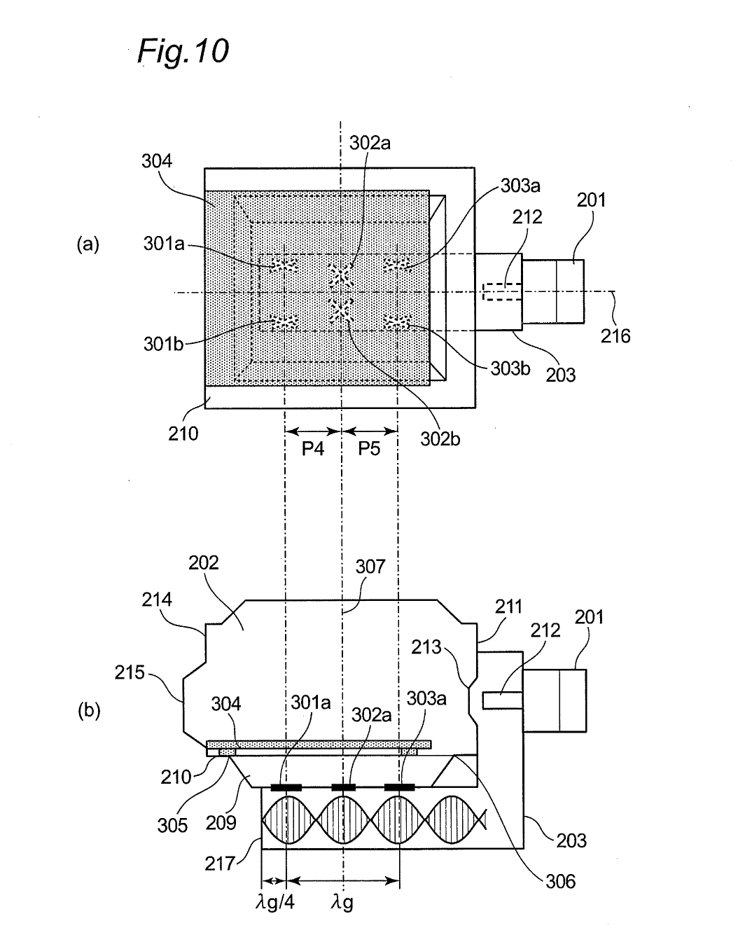

Further, in the microwave oven of the third embodiment, the placement plate 304 is configured not to fix to the wall surface of the heating chamber 202, but to be attached and removed optionally. For this reason, for example, when the placement plate 304 becomes dirty, the placement plate 304 can be removed from the heating chamber 202 and can be washed easily. In the conventional microwave heating device, in the case that a rotating antenna which radiates microwave is formed in the bottom of the heating chamber, electrical components, such as a motor for rotating the rotating antenna mechanically, are arranged at the bottom of the heating chamber. For this reason, it is desirable that the structure is configured that water or steam, which may cause a short circuit electrically, does not come into the bottom of the heating chamber. Therefore, it is necessary to adhere putty and packing for sealing an aperture between the bottom of the heating chamber and the placement plate. On the other hand, in the structure of the third embodiment according to the present invention, it is not necessary to pay attention to water and steam as the conventional structure, because the electrical components are not disposed in the bottom of the heating chamber. In the third embodiment, the placement plate 304 can be structured so as to be attached and removed optionally. For this reason, when using the microwave heating device having the structures of the third embodiment, as shown in (b) of FIG. 9, user puts the placement plate 304 on a difference in level on the bottom face 210 of the heating chamber 202 so as to form a bottom space 209 on the bottom face 210. Incidentally, in the structure of the third embodiment, since the placement plate 304 can be attached and removed freely, it is possible to place the placement plate 304 on a position shifted from a correct position. FIG. 10 is a figure showing an example when the placement plate 304 is shifted and placed on the left side from the correct position.

With the structure of the third embodiment, the right-side and left-side wall surfaces of the heating chamber 202 have shapes which are not symmetrical. Also, the placement plate 304 may not be symmetrically disposed in the heating chamber 202 depending on the way of placing of the placement plate 304. Then, in the structure of the third embodiment, its attention is paid to the bottom space 209 as a radiation area for discussing symmetry.

In the structure of the third embodiment, in the propagation direction of the waveguide tube 203, the interval between the center position of the openings 301a, 301b and the center position of the openings 303a, 303b has only approximate the in-tube wavelength λg (Lambda g), and especially the center position of the openings 301a, 301b is disposed to have the interval of ¼ λg from the end portion 217 of the waveguide tube 203.

As shown in (b) of FIG. 9, the bottom space 209 has a small lower part (the openings-forming side), and a large upper part (the placement plate side). In the structure of the third embodiment, as shown in (a) of FIG. 9, the left-end portion 305 above the bottom space 209 is formed so as to have an interval of ½ λg in the propagation direction of the waveguide tube 203 from the center position of the openings 301a, 301b which are close to the end portion side in the propagation direction of the waveguide tube 203. Also, the right-end portion 306 above the bottom space 209 is formed so as to have an interval of ½ λg in the propagation direction of the waveguide tube 203 from the center position of the openings 303a, 303b.

The bottom space 209 formed as mentioned above spreads gradually from the openings-forming side which is the lower part of the bottom space 209, and eventually the length from the left-end portion 305 to the right-end portion 306 becomes twice the in-tube wavelength (2 λg) in the propagation direction of the waveguide tube 203. The space from the left-end portion 305 to the right-end portion 306 in the bottom space 209 constitutes the radiation area. In the case that the radiation area is defined as mentioned above, an equivalent quantity of the microwave is always radiated from the openings 301a, 301b, 303a, 303b which are formed at just the middle position of the intervals between the left-end and right-end portions 305, 306 of the bottom space 209 in the propagation direction of the waveguide tube 203 and the center 307 (refer to FIG. 9) in the lateral direction of the bottom space 209, in the structure of the third embodiment. Therefore, in the structure of the third embodiment, the microwave can be uniformly radiated to the whole radiation area from the left-end portion 305 to the right-end portion 306 of the bottom space 209, and thereby the object to be heated can be heated uniformly without using a driving mechanism.

In particular, like the microwave oven of the third embodiment, when the surfaces of the side walls of the heating chamber 202 has unevenness, even if it is going to decide a distance of the radiation area between side walls of the heating chamber 202, the distance itself will change in response to the positions to be measured. Also, with regard to the placement plate 304, in case that the placement plate 304 can be attached and removed optionally and has degree of freedom for the placement, and that the placement plate 304 having an asymmetrical shape (not shown) is used, even if it is going to decide a length of the radiation area with the placement plate 304, it may not be decided certainly. Therefore, in the above-mentioned third embodiment, by defining the radiation area from the left-end portion 305 to the right-end portion of the bottom space 209, a range of the radiation area can be determined certainly and it becomes easy to discuss the distance from the positions of the openings for radiating the microwave with respect to the radiation area.

Hereinafter, an operation and an effect of the microwave oven, which is the microwave heating device according to the third embodiment of the present invention, will be described.

The microwave oven of the third embodiment includes the heating chamber 202 which is adapted to house the object to be heated, the magnetron 201 which is adapted to generate the microwaves, the waveguide tube 203 which is adapted to transmit the microwave, and the six openings 301a, 301b, 302a, 302b, 303a, 303b which are adapted to radiate the microwaves from the waveguide tube 203 to the heating chamber 202. The heating chamber 202 has the bottom space 209 as the radiation area approximate twice the length (2 λg) of the in-tube wavelength (λg) in the propagation direction of the waveguide tube 203. The openings 301a, 301b and the openings 303a, 303b, which are arranged in both ends in the propagation direction, are formed to have the interval of approximate the in-tube wavelength in the propagation direction of the waveguide tube 203, and are symmetrically arranged with respect to the center line 307 extending in the front-back direction of the bottom space 209. The openings 301a, 301b and the openings 303a, 303b, which are disposed at the both end sides having the interval of the in-tube wavelength, are symmetrically arranged with respect to the center line 307 of the bottom space 209 which has approximately twice the length of the in-tube wavelength in the propagation direction of the waveguide tube 203. Therefore, the openings 301a, 301b and the openings 303a, 303b on the both ends in the propagation direction are prepared in just the middle position between the center 307 in the propagation direction of the bottom space 209 and the left-end and the right-end portions 305, 306, respectively. Moreover, since the openings 301a, 301b and the openings 303a, 303b in the both ends in the propagation direction of the waveguide tube 203 are arranged to have the interval of the in-tube wavelength, these openings always becomes the spatial relationship that the same phase arises, and can always radiate an equivalent quantity of the microwave towards the heating chamber 202 from the inside of the waveguide tube 203.

As mentioned above, in the microwave oven of the third embodiment, since the equivalent quantity of the microwave can always be radiated from the openings 301a, 301b and the openings 303a, 303b, which are disposed at just the middle position from the center 307 of the bottom space 209 to the both end portions 305, 306, the microwave oven of the third embodiment can uniformly heat the whole area from end to end in the lateral direction (the propagation direction) of the bottom space 209, and thereby the object to be heated can be heated uniformly without using a driving mechanism.

In the microwave heating device illustrated as the microwave oven of the third embodiment, the radiation area is defined with the bottom space 209 which is formed when the placement plate 304 is arranged at the predetermined position above the openings 301a, 302a, 303a, 301b 302b, 303b. Thereby, the equivalent quantity of the microwave can always be radiated from the openings 301a, 301b and the openings 303a, 303b which are disposed at just the middle position of the distance from the center 307 in the lateral direction (the propagation direction) of the bottom space 209 to each both end portion 305 or 306. As a result, the microwave heating device of the third embodiment can uniformly heat the whole area from end to end of the bottom space 209, and thereby the object to be heated can be heated uniformly without using a driving mechanism.

### Fourth Embodiment

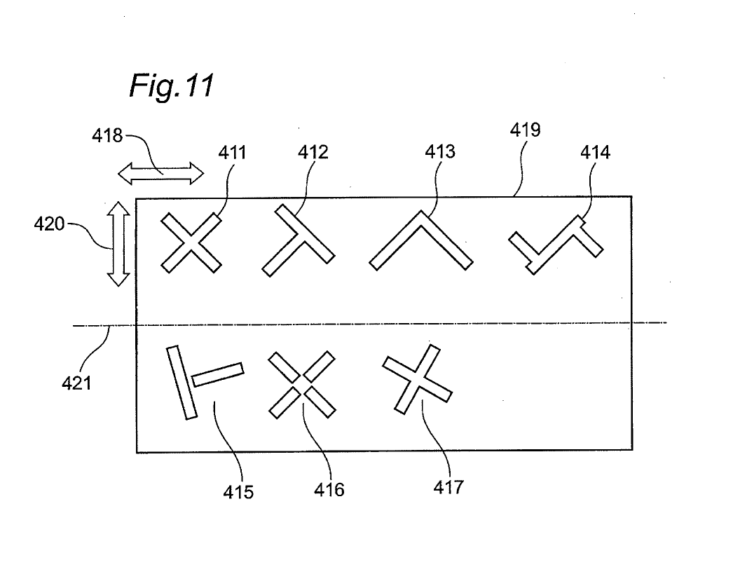

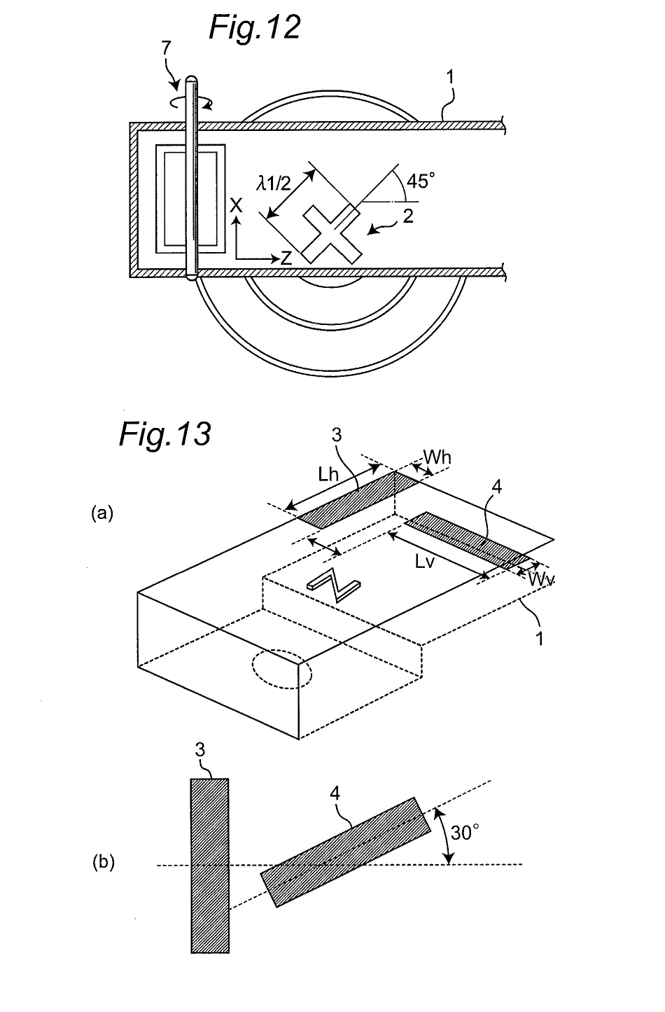

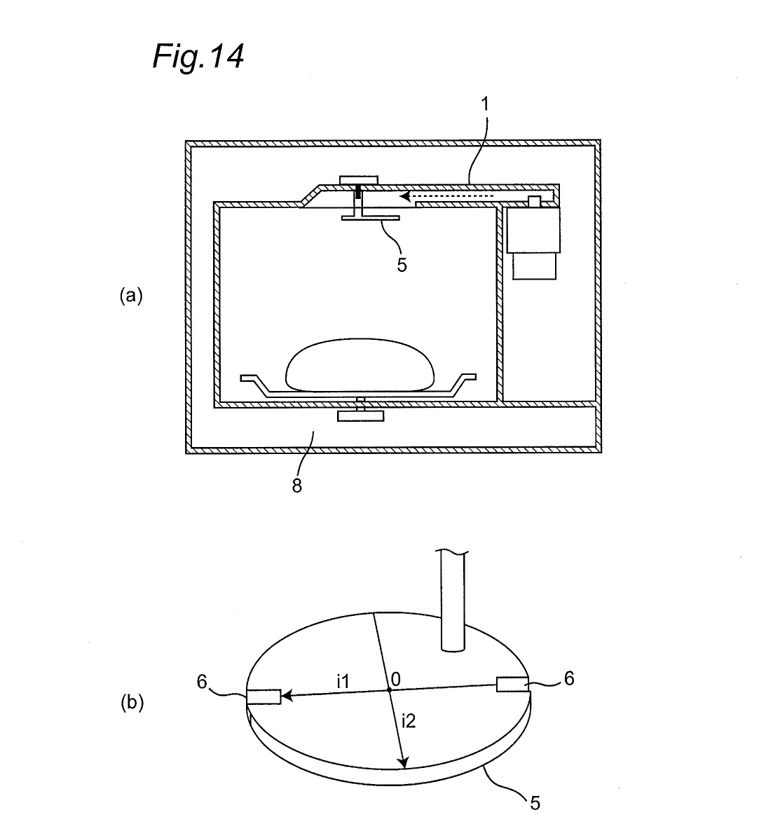

Hereinafter, a microwave heating device according to a fourth embodiment of the present invention will be described, with reference to drawings. FIG. 11 is a diagram explaining shapes of openings as microwave radiating portions in a microwave heating device, for example, a microwave oven according to the fourth embodiment of the present invention. In the structure of the fourth embodiment, a difference point from the structures of the first embodiment to the third embodiment is a shape of the opening, and the residual components of the fourth embodiment are configured to have the same components as the first embodiment to the third embodiment.

In the microwave heating device of the fourth embodiment, the shape of the opening, which is constituted by at least two or more elongated holes (slits), and which is a microwave radiating portion for radiating the circular polarization, is described.

The openings 411-417 shown in FIG. 11 are constituted by two or more elongated holes. In the openings 411-417, the long side of at least one elongated hole should just be formed to be inclined to the propagation direction (refer to arrow 418) of the microwave. Therefore, it may be sufficient that a shape has an elongated hole which does not intersect like the opening 415 and the opening 416, and that a shape is constituted by three elongated holes like the opening 414.

Also, the following three points are mentioned for the best shape of the opening as the microwave radiation part which radiates the circular polarization, and which is constituted by two elongated holes (slits).

The first point is that the length of the long side of each elongated hole is or more about ¼ the in-tube wavelength λg in the waveguide tube 419.

The second point is that two elongated holes are at right angles each other and that the long side of each elongated hole inclines to the propagation direction 418 (for example, 45 degrees).

The third point is that openings are arranged in order that distribution of an electric field of the waveguide tube 419 is not formed symmetrically centering on the straight line which passes through the centers of the openings as microwave radiation parts, and which are parallel to the propagation direction 418. For example, in the case that microwave is being transmitted with the TE10 mode, since the electric field is distributed symmetrically centering on an axis of symmetry as the tube axis 421 (refer to FIG. 11) which is a center line in the width direction 420 of the waveguide tube 419, it is the best condition to arrange the openings so that the shapes of the openings are not arranged as axial symmetry to the tube axis 421, namely so that the centers of the openings are not become on the tube axis 421.

Although the elongated holes (slits) are arranged to be at right angle each other as illustrated in FIG. 11, as the structure illustrated in FIG. 9 of the third embodiment, it may be sufficient that an opening has a crushed X-like form having a short length in the width direction of the waveguide tube so that the elongated holes are arranged to incline without making the elongated hole intersect perpendicularly. Even when the opening (the microwave radiating portion) having the crushed X-like form is used, the opening can radiate the circular polarization, although the circular polarization changes from a perfect circle to an ellipse. Therefore, the center of the opening can be brought near by the end side in the width direction of the waveguide tube without making the elongated hole of the opening for radiating the circular polarization small. As a result, the microwave can mainly be extended further to the width direction (the direction perpendicular to the propagation direction) of the waveguide tube.

Further, as shown in FIG. 11, the opening in the structure according to the fourth embodiment of the present invention may be configured to have an L-like form as the opening 413, and a T-like form as the opening 415. For this reason, as the above-mentioned Patent Literature 2 shown in FIG. 13, the structure of the present invention can apply to that two openings are arrange to have an interval. Moreover, as shown in (b) of FIG. 13, the structure of the present invention can apply to that two elongated holes (slits) are not at right angle each other, for example, they may be arranged to have about 30 degrees angle between them.

Also, in the structure of the fourth embodiment, the elongated hole (slit) which constitutes the opening as the microwave radiating portion is not limited to a rectangle shape. For example, corners of the opening may be formed to have a curve portion (R), and the opening may be formed in an ellipse shape so as to generate the circular polarization. As a view of a fundamental shape of an opening for radiating the circular polarization, the shape of the opening may be formed just by combine two elongated shapes, each of which has a shape constituted by that one side is long and the other side which intersects perpendicularly to the one side is short.

The microwave heating device according to the present invention includes a heating chamber (102, 202) which is adapted to house an object to be heated, a microwave generating portion (103, 201) which is adapted to generate microwave, a waveguide tube (104, 203) which is adapted to propagate the microwave, and a plurality of microwave radiating portions which are adapted to radiate the microwaves from the waveguide tube to the inside of the heating chamber. The heating chamber includes a radiation area which is irradiated with the microwaves from the plurality of the microwave radiating portions, and which has a length of approximate twice an in-tube wavelength in a propagation direction of the waveguide tube. At least two of the microwave radiating portions are positioned to have an interval of approximate the in-tube wavelength, and are symmetrically arranged to the center line which intersects perpendicularly to the propagation direction in the radiation area.

In the microwave heating device according to the present invention, two microwave radiating portions, which are positioned to have an interval of the in-tube wavelength, are symmetrically arranged in the radiation area which has a length of approximate twice the in-tube wavelength. Therefore, each of the microwave radiating portions is disposed at just the intermediate position between the center of the radiation area and each end of the radiation area. Also, since the two microwave radiating portions are positioned to have the interval of the in-tube wavelength, two microwave radiating portions are arranged at the positions having always the positional relationship that the same phase arises, and can always radiate an equivalent quantity of the microwave to the heating chamber from the inside of the waveguide tube.

As mentioned above, the microwave heating device according to the present invention, since an equivalent quantity of the microwave can always be radiated from two microwave radiating portions, which are disposed at just the intermediate position between the center of the radiation area and each ends of the radiation area, the microwave heating device can radiate the microwave to the whole area from end to end of the radiation area, and thereby an object to be heated can be heated uniformly without using a driving mechanism.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### INDUSTRIAL APPLICABILITY

The microwave heating device of the present invention can be used effectively in the heating device which performs a heating process of an object to be heated, such as food etc. and a sterilizing process and the like, because the object to be heated can be uniformly irradiated with the microwave.

### REFERENCE SIGNS LIST

101: Microwave oven (Microwave heating device)
102, 128, 202: Heating chamber
103, 201: Magnetron (Microwave generating portion)
104, 130, 203, 419: Waveguides tube
105, 106, 129, 204a, 204b, 205a, 205b, 206a, 206b, 207a, 207b, 301a, 301b, 302a, 302b, 303a, 303b, 411, 412, 413, 414, 415, 416, 417: Opening (Microwave radiating portion)
111, 112: Wall surface
208, 304: Placement plate (Radiation area)
209: Bottom space (Radiation area)

1. A microwave heating device comprising:
a heating chamber which is adapted to house an object to be heated;
a microwave generating portion which is adapted to generate a microwave;
a waveguide tube which is adapted to propagate the microwave; and
a plurality of microwave radiating portions which are adapted to radiate the microwaves from the waveguide tube to the inside of the heating chamber, wherein
the heating chamber includes a radiation area which is irradiated with the microwaves from the plurality of the microwave radiating portions, and which has a length of approximate twice an in-tube wavelength in a propagation direction of the waveguide tube, and wherein
at least two of the microwave radiating portions are positioned to have an interval of approximate the in-tube wavelength, and are symmetrically arranged to the center line which intersects perpendicularly to the propagation direction in the radiation area.

2. The microwave heating device according to claim 1, wherein the radiation area is defined with a placement plate for placing an object to be heated.

3. The microwave heating device according to claim 1, wherein the radiation area is defined with a space between facing wall surfaces of the heating chamber.

4. The microwave heating device according to claim 1, wherein the radiation area is defined with a bottom space between a position of the microwave radiating portions and a position of a placement plate above the microwave radiating portions.

5. The microwave heating device according to claim 1, wherein at least two of the microwave radiating portions are configured to be arranged at positions adjacent to anti-node of a standing wave generated within the waveguide tube.

6. The microwave heating device according to claim 1, wherein at least two of the microwave radiating portions are arranged along the propagation direction of the waveguide tube, and at least another microwave radiating portion is formed at a position between the at least two of the microwave radiating portions.

7. The microwave heating device according to claim 1, wherein at least two of the microwave radiating portions are arranged to be in juxtaposition every two thereof in a width direction of the waveguide tube.

8. The microwave heating device according to claim 1, wherein the microwave radiating portions have shapes of openings adapted to radiate circular polarizations.

9. The microwave heating device according to claim 8, wherein the microwave radiating portion for radiating the circular polarization is configured with an opening which has an X-like form shaped by two elongated openings intersected with each other.
